(19) United States
(12) Patent Application Publication
(10) Pub. No.: US 2012/0192231 A1
(43) Pub. Date: Jul. 26, 2012

(54) Web computer TV system

(76) Inventor: Shalong Maa, Arlington, TX (US)

(21) Appl. No.: 13/199,031

(22) Filed: Aug. 18, 2011

Related U.S. Application Data
(60) Provisional application No. 61/461,545, filed on Jan. 20, 2011.

(51) Int. Cl. G06F 3/00

(52) U.S. Cl. 725/38

(57) ABSTRACT

Disclosed herein is a window-based computer system (30) fully operated/controlled by either a remote control (710) or by a mouse for facilitating users' interaction with live TV events and allowing personally targeted TV advertising messages to be individually delivered to each TV viewer. The remote control includes only six OS-related functional keys for providing unlimited functions, including all forms of window manipulations/controls, easy access to files, application programs, tools, and to any display items. A user account on local computer remains associated with a web portal account of the user such that live personal information received from web site (300) may be presented within a live-information section (981) on the desktop (900). Moreover, the computer system allows a user to interact with any messages displayed as screen savor by designating a screen-savor-interaction key on the keyboard, and allows more than one person to work on the same file/project simultaneously.

### CROSS-REFERENCE TO RELATED APPLICATIONS

The present application claims the benefit of provisional application no. 61/461,545, filed Jan. 20, 2011 by the applicant, which stems from and claims the priority and all other benefits of U.S. patent application Ser. Nos. 11/881,991 filed 30 Jul., 2007, 12/002,325 filed 17 Dec. 2007, 12/002,326 filed 17 Dec. 2007, and 12/070,360 filed 19 Feb. 2008, of which the complete disclosures are incorporated fully herein by reference. The present application is also related to U.S. patent application Ser. Nos. 11/708,134, 11/607,835, 11/542,035, 11/542,034, 11/541,486, 11/517,950, 11/174,433, 10/688,269, and 09/919,187, including all other prior applications referred to and/or incorporated by reference therein.

### TECHNICAL FIELD

The present invention pertains generally to a user-friendly computer interface system and, in particular, to a remote-control based computer interface system that allows a user to use a handheld remote-control device to conveniently interact with a window-OS based multimedia computer, and to a computer system that takes full advantage of the electronic network system such as the Internet for the purpose of providing better user experience and improving collaborations and productivity.

### BACKGROUND OF THE INVENTION

As it is well known, the current TV technology does not facilitate user interaction with a live TV event such as interaction with a TV advertising message. There is still no product in the market that provides the user experience of fully interacting with a computer and with the Internet in a TV-watching environment. This is because, the prior art failed to provide a window-based computer OS that can be easily operated or controlled by a simple handheld remote control device, or HRCD. Consequently, a user is required to sit very close to the computer monitor in order to use the computer mouse as a user input/pointing device to interact with the computer.

It is also well known, the Internet facilitates various forms of user interactions and transmission and communication of live information. Currently, such rich interactive features of the Internet digital media are limited to the situation where a user uses a web browser to visit a service provider's web site. This is because of the design of the existing personal home computer operating system in the market. The existing enterprise computer OS systems in the market, such as the well known Window XP Enterprise OS, are designed to require user of each computer connected to the LAN to log onto the network system; The user usually remains logged on while working on the computer network so as to have easy access to the shared resources, such as files, database, or printers, etc., on the networks. However, the existing home computer system in the market, such as the Windows XP Home OS, is designed to make a local computer user account independent of any of the computer user's web portal accounts (such as the user's Yahoo account). The ISPs are usually not the providers of any online resources other than serving as a point of “Gateway” or “Connection”.

A drawback of the existing home computer OS in the market is, it is not feasible to directly present, on the desktop or on the screen savor, live personal information received through the Internet. Another drawback of the existing home computer OS in the market is, the screen savor is made completely “untouchable”, i.e., it will be turned off when a user touches the mouse or any of the keys on the keyboard; Thus, the screen savor cannot be used for display of any interactive messages. The screen savor function of the existing personal computer OS in the market, such as that of the Window Vista, is currently treated as a mean of entertainment; It was originally employed for the purpose of “saving” the screen, which is now deemed unnecessary with the advent of the related hardware technologies. Another drawback of the existing personal computer system in the market is, it does not facilitate real-time collaborations—it does not allow more than one person to work on the same file at the same time, with each one having live update of other people's works. Such a real-time collaboration feature is important, especially when many people are collaborating in working on a large file/project, such as on a spreadsheet file with thousands of rows/columns, or on a large CAD project, or when many people are updating or commenting on a presentation work or on a file at the same time during a conference, etc.

### SUMMARY OF THE INVENTION

To remedy the foregoing and other drawbacks of the prior art and to achieve other objects of the present invention, there is provided and disclosed herein a novel HRCD-based computer TV system. Although it is a full-blown window-based OS that is fully suitable to be operated or controlled by a conventional computer mouse, the HRCD-based computer TV system of the present invention can also be fully and easily controlled and operated by a HRCD with the minimum usage of the trackball provided on the HRCD; Such a feature is necessary since it is not convenient for a user to use a pointing device such as a mouse or trackball to interact with the OS's user interface when the user is sitting about 5 to 10 feet away from the display. In such a TV-viewing environment, the user will always prefer the simple action of pressing keys on the HRCD. Since the computer TV of the present invention is a full-blown window-based OS, in order to minimize the usage of the trackball, the HRCD will need to provide the user with many window-operation functions; On the other hand, if the HRCD includes too many functional keys, it would be difficult for a user to use it, since the user will be confused. The remote control system of the present invention is designed (i) to have minimum number of keys on the HRCD that provide shortcut accesses to unlimited number of user interaction functions, (ii) to make it very easy for a user to perform all forms of window manipulations, and (iii) to make it very easy for a user to scroll and to enlarge any portion of the display. Again, all these can be accomplished without requesting extensive usage of the trackball.

Unlike the conventional personal computer in the market, the computer TV system of the present invention is more than just a personal computer; It is also an online home entertainment system that can be enjoyed by an entire family together, using multiple HRCDs. The HRCD includes only six OS-related functional keys that, even with a minimum usage of a trackball, will provide unlimited user-interaction functions, including all forms of window manipulations and controls, easy access to files, folders, application programs, application tools, and to any display items; In addition, the simple HRCD allows easy display-content scrolling, easy typing without a full keyboard, and easy view enlargement. The HRCD of the system includes a bookmark key for bookmarking a web page associated with a live TV show/event. When the user is interested in the current TV show/event or the current TV advertising messages, the user can simple press the bookmark key of the HRCD, which will cause the web page directly associated therewith to be “bookmarked” by the computer TV system. The user can then uses the HRCD to easily retrieve such bookmarked TV web pages at a later time. The bookmarked web page may be briefly and automatically presented to the user when the user is playing back a pre-recorded TV shows. Alternatively, such bookmarked web page may be presented or displayed to the viewer (e.g., within a separate window) next to the corresponding current TV event being shown immediately after the user presses the bookmark key of the HRCD.

A tremendous advantage of the computer TV system of the present invention is, it facilitate personally targeted TV advertising, i.e., instead of “broadcasting” the same TV advertising message to all the subscribers in an entire metro area, each TV advertising message to be presented to each individual subscriber during the TV commercial break will (i) be selected based on the user's online activities, (ii) be pre-downloaded to the computer TV client system of the subscriber in advance in exchange for the free services of recording and pausing the TV shows, and (iii) be played back during the TV commercial break. It is preferred that, when a subscriber plays back a recorded TV show, she will not be allowed to entirely skip all the TV commercial messages; But instead, each TV commercial message can be made much shorter (e.g., 15 seconds instead of 30 seconds), and be pre-downloaded to the subscriber's client computer TV system in advance.

The meanings of the remote-control device related terms and phrases used herein and in the annexed claims are set forth as follows: (A). The term “HRCD”, which stands for “handheld remote control device”, means a device that, during its conventional use or operations, a user usually hold it in his/her hand (i.e., it is physically supported by the user's hand), which is different from a full keyboard. When a user is using a full keyboard, such as during the typing, the keyboard is usually not physically supported by the user's hand; it is usually situated on or physically supported by a table or the user's lap. Moreover, a HRCD is usually much smaller and, in most cases, a user uses his/thumb to press or activate most of the keys on the keypad of the HRCD; whereas a user usually only use his/her thumb to press the space bar on the conventional keyboard during the typing. The HRCD is also different from the conventional cell phone or smart phone in that, (i) as for the HRCD, the primary display device, the TV set/monitor, is usually more than three feet away from the body of the HRCD, whereas in case of cell phone, the primary display device and the keypad are usually connected together.

(B). The term “HRCD-input subsystem” of the computer system means the subsystem employed in the computer for receiving the wireless user-input signals transmitted from a HRCD.

(C). The term “a HRCD signal” means wireless signal(s) that, (i) is transmitted from a HRCD, (ii) represents a user's operation or activation of press keys on the keypad of the HRCD; and (iii) there is one or more predefined (length of) “time interval(s)” for separating different user operations of said keys on the keypad of the HRCD. For examples, (a) when a user presses or activates a key “A” and a key “B” on the keypad of the HRCD, and the “time interval” between such two actions is, for example, 0.5 second; then when the resultant wireless signals from the HRCD is received by the computer system, they will be interpreted together as one integrated instruction, and thus they will be regarded as “a HRCD signal”; (b) when the user presses or activate the key “A” first, and then activate the key “B” three second thereafter, then when the computer receives the resultant wireless signals from the HRCD, such signals will not be interpreted together, and will be regarded as representing the two separate operations or instructions because of the time interval of three second is longer than a predefined length of time interval of, for example, 0.65 second; (c) when the user presses or activates the three different keys on the HRCD for a total of four times, i.e., key “A” once, key “B” twice, and key “C” once, with a total time of these actions of within 2 seconds (for examples) and the longest time interval between these actions is less than (for example) 0.64 second, then the resultant wireless signals transmitted from the HRCD will be interpreted together and be regarded by the computer as “a HRCD signal” for representing an integrated instruction(s).

(D). the term “operation of a HRCD key” or “operation of a (HRCD) number key” means either (i) pressing or activating by the user of a single key on the keypad of the HRCD or (ii) pressing or activating more than one keys on the keypad of the HRCD (i.e., “a combination of operations”). It is also understood that the foregoing only pertains to how the computer interpret the wireless signals transmitted from the HRCD; and it is not necessary that the computer will only perform one action in response to receiving “a HRCD signal”. In some cases, two separate operations of the HRCD keys may be equivalent to one integrated operation involving two HRCD keys. This is often the case when pressing a first key will cause a display of a menu, with each item therein associated with a number, and the second key is a number key for activating one of the items in the menu that is associated with the corresponding number. When a number label is displayed next to an item (see below), such a display is for reminding the user which number is assigned thereto. Then user can look at the display to decide which number key is to be activated.

According to another aspect of the present invention, a home computer shall be made similar to (but not as complex as) an enterprise computer, i.e., (i) when a user is logged onto his personal account on the local home computer, the local client computer will automatically establish an connection or association of such client personal account with an online account of the user such, for example, as a web portal; (ii) the user's local client personal account shall remain connected to the associated online account until the user is logged off from the local client home computer. The purpose of such an arrangement, as far as user experience is concerned, is to let the user have much easier access to personal information provided by the web portal, and to present on the client computer desktop live update of certain personal information, such, for examples, as number of new emails, alerts for certain events or deadlines (such as bill payment deadlines or appointment schedules), whether a friend is back from her vacation, latest bids or delivery status of an online auction item, in association with a user's online dating account, the number of new people interested in meeting the user, and in association with a user's online job-search account, number of employers who recently viewed the user's resume, etc., etc. Thus, by associating each user account of a local computer with a online (web portal) account of the user, a variety of live information can be automatically presented live right onto the user's desktop or even be displayed as a screen savor. The user can entirely avoid the complex process of launching the web browser application, going to the web site of each individual service providers one by one, logging in and browsing before finding the desired personal information (if the user can remember doing it). It is understood that, such an arrangement of associating a local user account of a local computer with a web service account (or the like) of the user is not limited to home computers; it may also be applied to any personal computer used in an enterprise or a local network environment. For example, within a LAN, a user account may be managed or administered by the local network system in the conventional manner as well as be associated with a web portal account of the user in the same manner as that of a home computer.

As it is well known, privacy is always an issue when an online service provider tries to keep track of users' online activities for the purpose of gaining business advantages. This will not be a major concern when the computer system of the present invention is distributed, since every user will be fully aware of the fact that his/her client desktop account always remains associated with his/her web portal account. Each user is subscribed to a web portal account right after the user finish setting up his/her client home computer system. The user's online activities and web search history will be recorded with the consent by the user in exchange for the free services of providing live information onto the user's desktop. Consequently, in case of web searching services, for example, the delivery of any web search result can be rendered based on the user's online activities and search history so recorded; Similarly, the display of web-search advertising can also be improved—the display of advertising messages that are to be presented next to each web-search result will be based in part on the aforementioned user's online activities and search history recorded, which will improve the likelihood of the advertising messages being clicked on by the user.

According to another aspect of the present invention, the screen savor of the computer system is regarded as a precious display “real estate” that is to be used for displaying interactive messages such as personal information associated with an online account of the user or interactive advertising messages. The interactivity of the screen-savor is provided through a specially designated screen-savor interaction key (or “SSI key”, such as the “Ctrl” key) on a conventional keyboard. The computer system of the present invention also includes a plurality of novel user-interface features, including features related to file/folder arrangement and display, scrolling of display content within a window, and to window manipulation and control.

According to yet another aspect of the present invention, more than one person can work on the same file at the same time, with each one having live update of any other people's work. In such a situation, each person's work will be saved into a LFMU (or “live file modification update”) file on the local computer in addition to being saved to the local copy of the file being worked on. As usual, on each local computer, the local copy of the file being worked on shall record the current version of the file; whereas the LFMU file only records the relative changed between the current version and the version immediately after the most recent remote update process. During each remote update process, it is the LFMU file, not the local copy of the file being worked on itself, will be transferred to the file server for update. When the file server receives a LFMU file from each user, it will trigger the OS of the file server to initiate a file update process, or a LFMU process, which includes opening and updating the original file based on the instructions and data included in the LFMU file received. Each local computer of the user who is working on the file will constantly send status request to the file server as to whether a new LFMU process associated with other users' work has been recently performed, and if so, will request the file server to transfer the corresponding LFMU file received by the server to the local computer for performing the same update process.

The foregoing is intended to be merely a summary, and not to limit the scope of the present specification. The features of the present invention that are believed to be novel are set forth with particularity in the annexed claims. The invention, together with further objects and advantages thereof, may best be appreciated by reference to the following detailed description taken in conjunction with the drawings.

### BRIEF DESCRIPTION OF THE DRAWINGS

FIG. 1 is a functional block diagram of an exemplary computer system for implementing the methods of the present invention.

FIGS. 2-4 are schematic representations of an exemplary HRCD of the computer TV OS of the present invention; FIGS. 3 and 4 are the front and side views, respectively, of the scrolling mechanism portion of the HRCD of FIG. 2.

FIG. 5 is a schematic view of an exemplary desktop view of the computer TV OS of the present invention.

FIGS. 6-8 illustrate exemplary expanded or pulled-down menu of the bookmark menu, the file manager menu, the application program manager menu, respectively, of FIG. 5.

FIG. 9 illustrates an expanded or dropped-down application tool menu of a exemplary media player application of the computer TV OS of the present invention.

FIGS. 10-11 illustrate an exemplary expanded or dropped-down menu of a window-manager menu of FIG. 5.

FIG. 12 is an enlarged view of a portion of FIG. 11 for demonstration of the view-enlargement method of the computer TV OS of present invention.

FIGS. 13-14 are exemplary computer displays for demonstrations of another view-enlargement method of computer TV OS of present invention.

FIGS. 15-16 are for demonstrations of the HRCD text-input method of the computer TV OS of the present invention. FIG. 15 is a schematic representation of the backside of the HRCD of FIG. 2.

FIGS. 17-20 are exemplary computer displays for demonstrating the methods of access to display items without moving the cursor of the computer TV OS of the present invention.

FIGS. 21-22 are schematic demonstrations of the MWFS display method of the computer TV OS of the present invention.

FIG. 23 represents an exemplary simplified data structure or data file that is to be transferred between two computers in association with the LFMU method of the computer OS of the present invention.

FIGS. 24-26 are schematic representations of exemplary desktop views of the computer OS of the present invention.

FIGS. 27-28 are schematic representations of an exemplary application window for demonstrating the “scrolling mark” method of the computer OS of the present invention.

FIGS. 29-31 are schematic representations of an exemplary folder for illustrating the folder search method and the methods of splitting and folding a window of the computer OS of the present invention.

FIGS. 32-33 are schematic representation of the i-poster note application of the computer OS of the present invention.

### DETAILED DESCRIPTION OF THE INVENTION

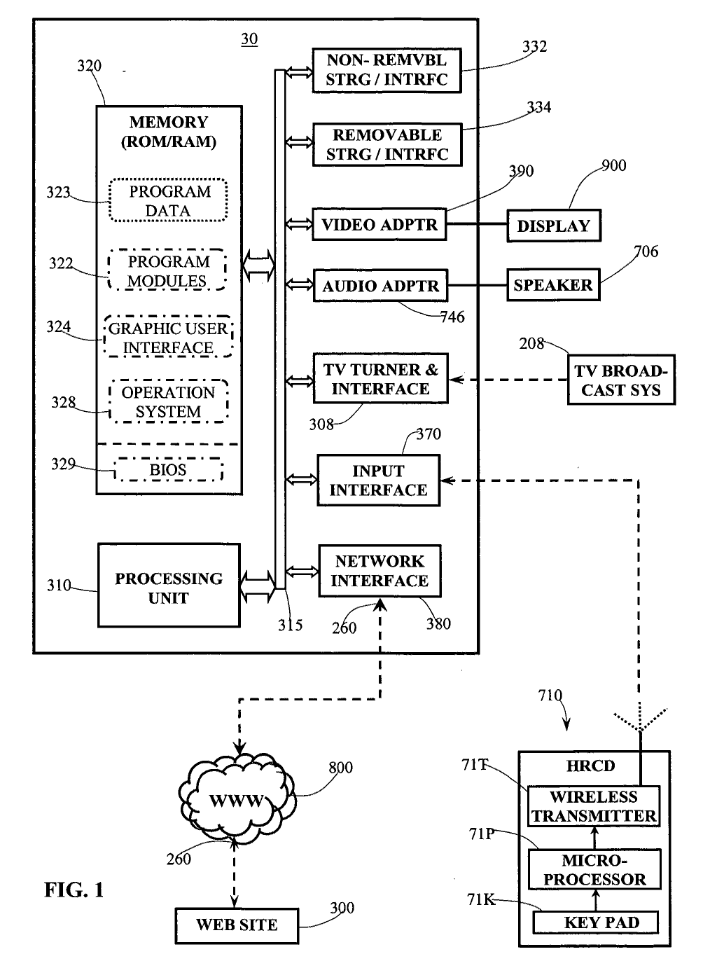

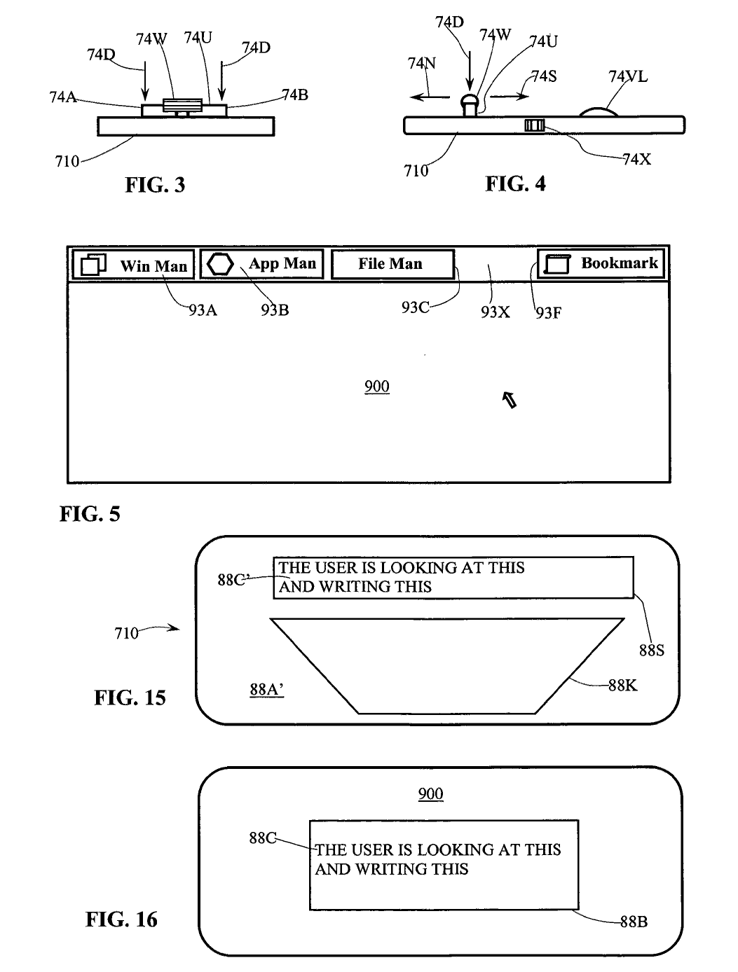

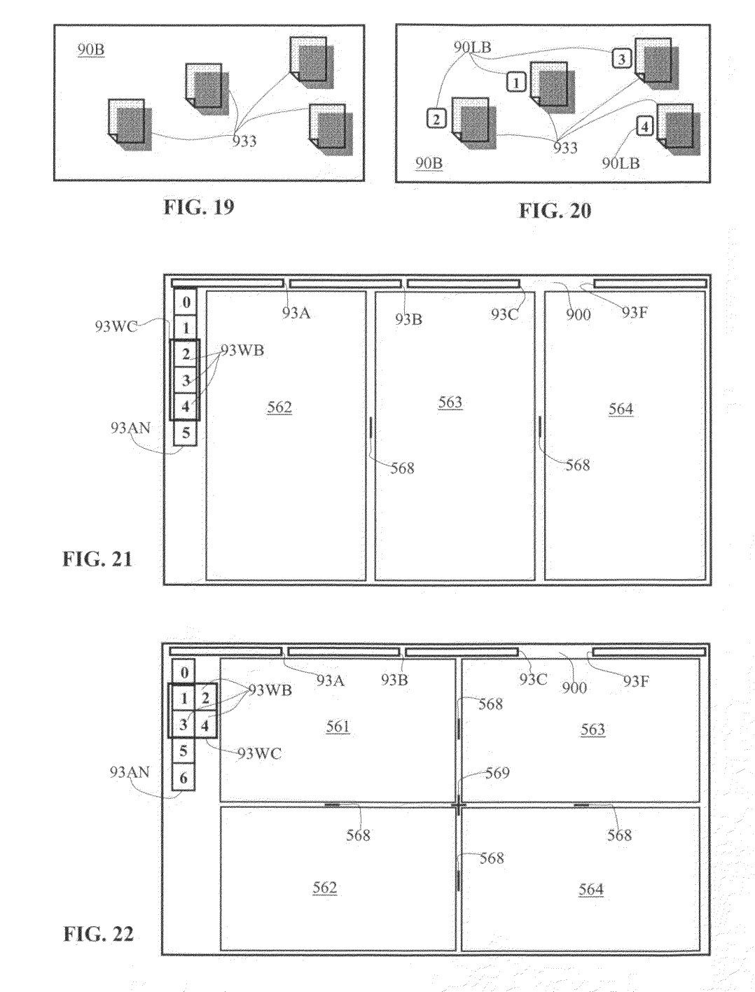

Referring to FIGS. 1-33, there are shown new and novel methods and systems for providing HRCD-based computer TV system according to the present invention. While the present invention is susceptible to embodiments in various forms, there is provided detailed description of the presently preferred embodiments, with the understanding that the present disclosure is to be regarded as exemplifications, and does not limit the invention to the specific embodiments illustrated. In some instances, for the purposes of explanation and not for limitation, specific reference or other numbers, diagrams, or dimensions, etc., may be set forth in order to provide a thorough understanding of the invention. In other instances, detailed descriptions of well-known elements, electronic circuitry, or computer or network components are omitted so as to not obscure the depiction of the invention with unnecessary details. In case where alternate arrangements of an element or component are described or displayed, like parts or components may be assigned with the same numerical reference numbers; In cases where boxes or functional block diagrams are used in the drawings, unless otherwise described in details in this specification, these boxes or functional block shown represent well-known or off-the-shelf electronic, software, or computer or networking components.

It shall also be understood that, in cases where the best mode is not particularly pointed out herein, the preferred embodiment described shall be regarded as the best mode; and that, in cases where best mode is alleged, it shall not be construed as having any bearing on or as contemplating the results of future research and development. The industrial exploitation of the present invention, such as the ways of making, using, and of the sales of the related software and hardware products, shall be obvious in view of the following detailed description.

Referring first to FIG. 1, in which is shown an exemplary computer system 30 and a simplified client-server architecture for implementing the concepts and methods of the present invention. As shown, in a very basic configuration, the client computer system 30 of FIG. 1 includes at least one processing unit 310 and a system memory 320. All the components of the computer system 30 described below may be connected to the processing unit 310 through a system bus 315 in a conventional manner. Depending on the type of configuration or type of computing device actually employed, the memory 320 may be volatile (such as RAM and the like), non-volatile (such as ROM and the like), or some combination of the two. The system memory 320 typically contains an operating system 328 and a basic input/output system BIOS 329. The BIOS 329 is usually stored in ROM and contains the basic routines that help to transfer information between elements within the computer 30, such as during start-up. The system memory 320 may also include one or more program modules 322 and program data 323, such as those described below in connection with the present invention. A Graphic User Interface (or GUI) system 324 may also be contained in the memory 320. The GUI 324 may be regarded as part of the operating system 328.

The computer 30 of FIG. 1 may also include additional features and functionalities. For examples, as shown, the computer 30 may also include a network interface subsystem 380 for allowing the computer 30 to communicate and interact with the Internet 800 and with other computer systems on the Internet 800, such as a remote server computer 300; a TV Turner subsystem 308 for receiving TV broadcasting signals from a TV station 208; and a display system 390 and a sound system 746 for interfacing and connecting a display device 900 and a sound device 706, respectively, to the computer 30. Typically, a user may enter commands and information into the computer 30 through an input device(s), such as a keyboard and/or a pointing device (e.g., a mouse or a remote control device). These user input devices are often connected to the system bus 315 and the processing unit 310 through a user input interface subsystem 370 (such as a serial port or the like). In the example of FIG. 1, the user input device of the computer 30 is a remote control device 710, in which case the input interface subsystem 370 shall include a wireless receiver for receiving wireless signals (such as IR signals) from the remote control 710. The computer 30 of FIG. 1 also includes, as shown, one or more non-removable data storage devices or media 332 (including an interface subsystem) and one or more removable data storage devices 334 (including an interface subsystem). Examples of these storage devices may include a magnetic disk, an optical disk, a magnetic tape or cassette, or a flash memory device, etc., or any other medium that can be used to store digital information. These storage media may be volatile or non-volatile. All information in the memory 320 may also be permanently stored in the non-removable storage media 332.

In FIG. 1, the local client computer 30, the Internet 800, and the remote server computer 300 represent an exemplary well known client-server interactive network architecture for implementing the methods of the present invention. The server computer 300 usually includes a Web server processing system for serving or providing any Web content requested by the client computer 30. The remote server computer 300 may also provide various other functionalities for allowing the users of the client computer 30 to interact therewith and with the Internet, such as sending E-mails, viewing a video clip, or requesting information from or sending personal information or requests to the remote server computer 300. In a typical request-response process for receiving information from the remote computer 300 by the client 30, the client system 30 specifies the URL or IP address of such Web content in a request, which is forwarded to the corresponding server computer 300 supporting such Web content. In response thereto, the server 300 sends the requested information or web content to the client 30.

Typically, the remote server computer 300 also includes one or more application programming system and one or more database system for implementing a business entity's various business applications. The information served on or provided by the remote server computer 300 and/or requested by the client computer 30 (i) may be a client-independent or static document or streaming media, such as a graphical Web page, or a audio/video clip, which are normally stored directly in the server computer 300's memory means in its database storage system; or (ii) may be dynamically created by said application program of the remote server computer 300 according to the client computer 30's specific requests. In a typical request-response cycle, the information relating to the user's specific requests, such as the user's username, ID number of the requested information, account status, etc., may be included in a “POST-method” request form (i.e., contained within the body of a HTTP POST request), or it may be appended to an URL (the HTTP “GET” request, which is equivalent to using the “GET” method in a request form) (or it may be sent to the server 300 through other standard manners), so as to tell the server 300 which specific information is being requested by such a client and/or how to configure the response to such client computer's such specific request. As for email access related operations, the standard mail access protocols such as IMAP provide standard text commands (such as “FETCH”, “SEARCH”, and “STATUS”, etc. in IMAP) for allowing the client application to have access to various information relating to messages transmitted/received through email protocols.

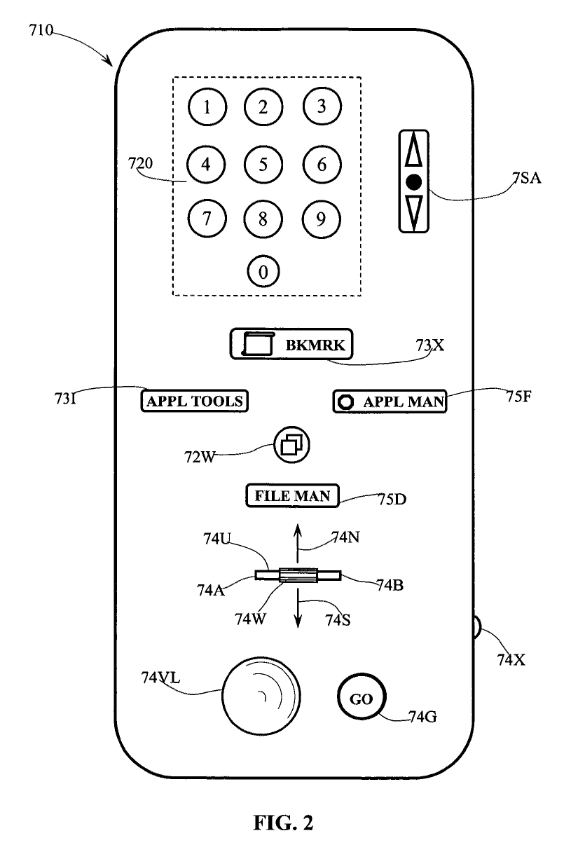

The functional structure of the HRCD device 710 of FIG. 2 is also shown in FIG. 1. The functional structure of the HRC 710 may be made the same as or similar to that of a conventional remote control device for use to control TV, DVD Player, and any other commonly used electronic appliances. As shown, the exemplary functional structure of the HRCD 710 includes a keypad 71K, a microprocessor 71P, and a wireless transmitter 71T. The microprocessor 71P controls the operation of the HRC 710 by accepting input data from the keypad 71K and sending commands and data to the transmitter 71T. The wireless signals transmitted from the transmitter 71T will be received by the wireless receiver of the input interface or subsystem 370 of the computer 30. Such a functional structure of the HRC 710 shown in FIG. 1 is regarded as the HRC device 710's transmitter circuitry. As used herein and in the annexed claims, the term “transmitter circuitry” of the HRC 710 means the portion of the functional structure designated as the reference number 710 in FIG. 1 or any other conventionally used feasible functional structure of a conventional handheld remote control device.

According to the present invention, a single computer TV system 30 can be operate or controlled by more than one HRDCs such that an entire family can enjoy the computer TV 30 entertainment system together at the same time. Within the computer TV 30 of FIG. 1, more than one HRCDs 710 may be provided for control of different windows displayed on the same display device 900 and supported by the same computer TV 30, in which case the wireless signals transmitted from each of the two HRCDs will include brief device-identification information such that a window opened by one HRCD will not response to wireless control signals transmitted from the other HRCD. Alternatively, if the computer TV 30 is provided with more than one HRCDs, one of these HRCDs 710 may be designated as having a higher control priority (i.e., the master remote control) then the other one 710′, such that a window opened by the non-master HRCD can be controlled by the master HRCD, while a window opened by the master HRCD will not response to the non-master HRCD.

A tremendous advantage of the computer TV system of the present invention is, it facilitate personally targeted TV advertising, i.e., instead of “broadcasting” the same TV advertising message to all the subscribers in an entire metro area, each TV advertising message to be presented to each individual subscriber during the TV commercial break will (i) be selected based on the user's online activities, (ii) be pre-downloaded to the client system of the subscriber in advance in exchange for the free services of recording and pausing the TV shows, and (iii) be played back during the TV commercial break. It is preferred that, when a subscriber plays back a recorded TV show, she will not be allowed to entirely skip all the TV commercial messages; But instead, each TV commercial message can be made much shorter (e.g., 15 seconds instead of 30 seconds), and be pre-downloaded to the subscriber's local client system in advance.

Evidently, the downloading of a HD TV commercial/advertising video (the “HDTVCV”) could require excessively large bandwidth. One solution thereto is to make each such HDTVCV shorter. The second solution is to carefully select the video image-frame graphic type (the “VIFGT”) of such HDTVCV during the video production stage. For example, the VIFGT of a football game, with about 30 athletes moving at high speed at the foreground of the video, with thousands of moving audiences at the background of the video, and with constant changing of camera angles, is of the type of less-compressible HD video; whereas the VIFGT of a HD video of a news broadcasting, with a single news anchor who is only moving her lips at the foreground of the video and with a static image at the background of the video, is of the type of much more compressible HD video. Whereas it's difficult or impossible to select the VIFGT of an HD entertainment video, such as that of a sports game or of a movie, the VIFGT of a HD video of a TV commercial message can be carefully arranged or selected at the video production stage to make it much more compressible without diminishing its advertising values.

Thus, as far as the bandwidth is concerned, it should not be difficult to achieve the aforementioned goal of presenting personally targeted TV advertising messages to each individual user during the TV commercial breaks. In order to be compatible with the existing system, the conventional manner of broadcasting TV commercial/advertising messages during the TV commercial break will be maintained; Thus, there will be no change at the TV broadcasting side of the system. In the meantime, the personally targeted TV advertising messages/video will be downloaded to each home local client system. At the home client side, during the TV commercial break, each client system will determine and manage how much of the broadcasted TV advertising messages are to be replaced by the downloaded personally targeted ones, based on factors such as the bandwidth, amount of HDTVCV downloaded/received, and whether the user is watching live TV broadcasting or is playing back a pre-recorded TV show, etc.

Six (6) Keys Providing Unlimited User-Interaction Functions.

As shown in FIG. 2, other than a conventional number key assemble 720 and TV channel surfing keys 7SA, the keypad of the HRCD 710 has six (6) functional keys that shall provide unlimited user-interaction functions, including (1) a bookmark key 73X, (2) an application program manager key 75F, (3) an application tools key 73I, (4) a window manager key 72W, (5) a file manager key 75D, and (6) an activation or “Go” key 74G, which is for activating an item located by cursor 920 in the conventional manner. Moreover, there is a conventional track ball 74VL on the keypad of the HRCD 710 for cursor control in a conventional manner and a scrolling mechanism 74U for scrolling display content within a currently active window. Each one of the functional keys of the HRCD 710, other than the “Go” key 74G, corresponds to a list of items, commands, or functions within a menu (see FIGS. 5-12); any of the items within such a menu may have sub-items.

The critical points of using these very limited number of functional keys or press buttons on the HRCD 710 to provide unlimited user-interaction functionalities are: (i) having these functional keys used in combination with the number keys 720 of the HRCD 710 such that a functional key in combination with different number keys will provide different functions; (ii) whenever feasible, displaying, next to each item in a dropdown menu, the number that is assigned to such item for indicating and showing to the user the association between the number key(s) 720 of the HRCD 710 and such item, so as to remind the user of which function/item is associated with which task number or with which number key of the HRCD. See FIGS. 6-12. Such an arrangement provides the user with very convenient shortcut means for access to a desired function. For any of the frequently used items or functions, the user only needs to use it a few times to remember which key combination on the HRCD 710 is associated thereto; Thereafter, the user will be able to quickly use such HRCD key combination (or shortcut) to easily gain access to such item or function without looking at the display. Pressing a few HRCD keys will be much faster and much more convenient than moving a cursor across the screen.

One of the most frequent activities of a computer TV user is watching TV; and almost all the users already have extensive experience of using a HRCD to interact with a TV. Thus it is preferred that, the default application of the computer TV OS 30 of the present invention be a TV/Video media player, and the default functions assigned to the TV channel surfing keys 7SA and to the number keys 720 of the HRCD 710 are selecting TV channel in a conventional TV-control manner. On the other hand, if the user depresses one of the foregoing functional keys 73X, 75F, 73I, 72W, or 75D of the HRCD 710 right before operating any of the number keys 720, it will activate an item or function within the corresponding menu that is assigned to or associated with such a number and functional key combination, in which case, the function of the number keys 720 will not be related to TV channel selections during the operation.

As shown in FIGS. 2 and 5, the HRCD 710 includes four (4) resource access keys, including a bookmark key 73X, an application program manager key 75F, a file manager key 75D, and a window manager key 72W. These four keys are provided for managing and accessing, respectively, the user's favorite web page URLs, the user's application programs, the user's document files, and the window displays. In association therewith, at the top portion 93X of the computer TV OS's desktop display 900, are provided with four corresponding resource access buttons (or unexpanded menus), including the bookmark button/menu 93F, application manager button/menu 93B, file manager button/menu 93C, and window manager button/menu 93A. Clicking on one of these functional manager buttons 93F, 93B, 93C, or 93A by a cursor will have the same effect as depressing the corresponding one of the functional keys 73X, 75F, 75D, or 72W, respectively, of the HRCD 710, which is to expand the corresponding menu, as is shown in FIGS. 6-11.

Easy Window Manipulations

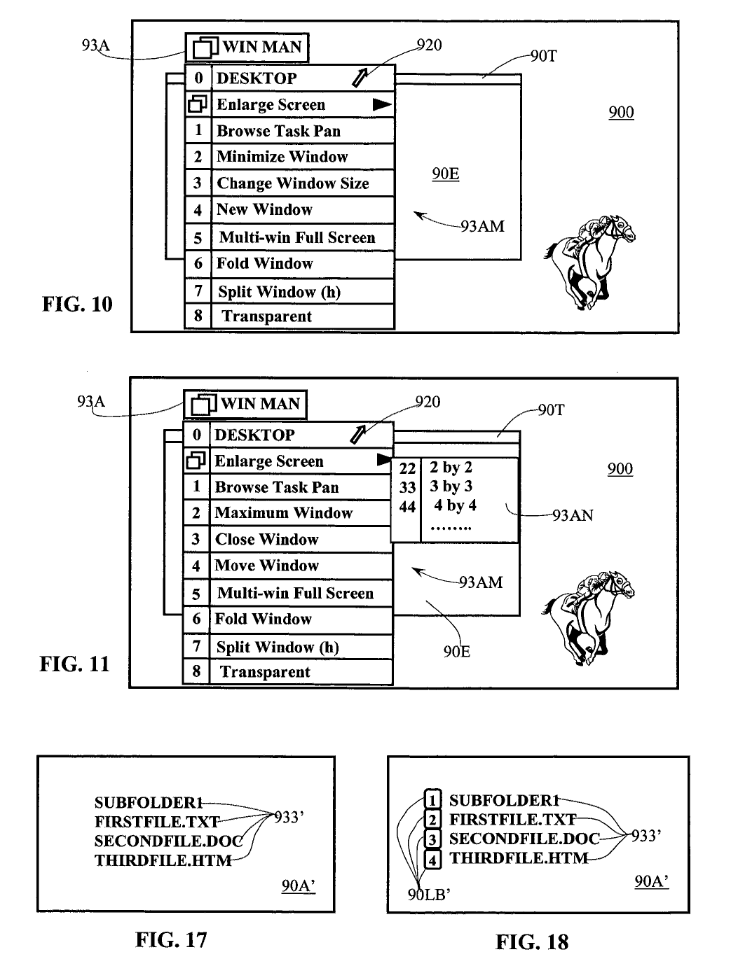

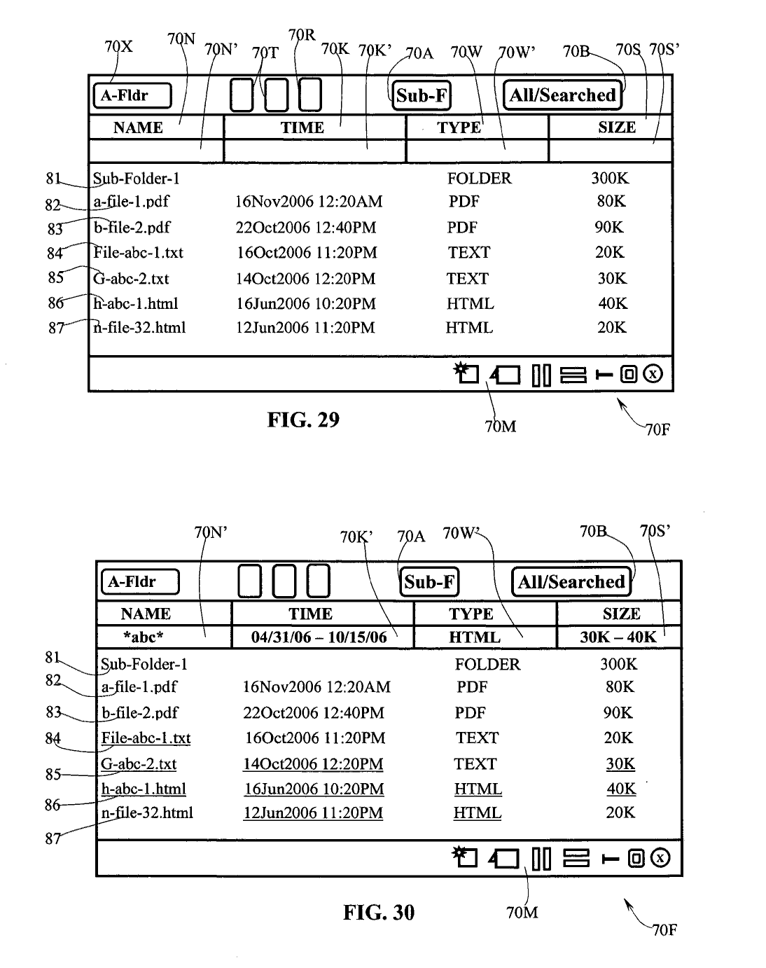

Reference is made to FIGS. 2 and 10-11 (FIGS. 10 and 11 represents two separate examples respectively). As shown, the “win-man” key 72W of the HRCD 710 is directly associated with a list of window management tools 93AM; depressing the key 72W will bring up and display such a window management function tools menu 93AM with each tool therein being associated with a number. Then the user may either use the scrolling wheel 74W of the HRCD 710 to browse through each item within the menu 93AM, or press one of the number keys 720 of the HRCD to activate the item in the menu 93AM that is assigned to such number. For examples, (i) in FIG. 11, within the menu list 93AM, the “window close” function is assigned to the task number “3” such that pressing the key 72W and then followed by the “3” key of the HRCD 710 will close the current active window 90E; and (ii) a “window split” function is assigned to/associated with the number “7” key such that pressing the key 72W and then the “7” key on the HRCD 710 will split the current window into two windows (See FIGS. 29-31); etc.

In FIG. 11, the function of “move window” is assigned to the task number “4” such that pressing the “win man” key 72W and then the “4” key on the HRCD 710 will cause the cursor 920 to move to the top portion 90T of the currently active window 90E so that the window 90E will be picked up by the cursor 920 such that the window 90E will follow the movement of the cursor 920; Thereafter, the user will use the track ball 74VL of the HRCD 710 to move the window 90E to a desired position; after which the user will press the “Go” key 74G of the HRCD 710 to drop the window 90E to such a new position, and the window 90E will be detached from the cursor 920.

Similarly, in FIG. 10, the function of “change window size” is assigned to the task number “3” such that pressing the window manager key 72W and then the “3” key (once) on the HRCD 710 will cause a first corner of the current window 90E to be located and picked up by the cursor 920; Thereafter, the user will use the trackball 74VL of the HRCD 710 to change the size of the window 90E, followed by pressing the “Go” key 74G of the HRCD 710 to have the cursor 920 release said first corner of the window 90E. If the user presses the “3” key twice (three, four times . . . ) (thus the task number are ‘33”, “333”, and “3333” . . . respectively) after pressing the window manager key 72W on the HRCD 710, a 2^{nd} (3^{rd}, 4^{th}) corner of the current window 90E will be located and picked up by the cursor 920 for the purpose of changing the size of the window.

Easy View Enlargement

When a user is sitting far away from the screen/monitor while using a HRCD to operate the window-based computer TV OS, often she will be in need for view enlargement. As shown in the exemplary FIGS. 10-11, the function of enlarging screen/view is the second item from the top of the window manager menu 93AM, and is assigned to or associated with the “win-man” key 72W (instead of any of the number keys 720) of the HRCD 710. This means that the function of view enlargement will be activated by double clicking the “win-man” key 72W on the HRCD 710. If the user does it slowly, the first pressing of the key 72W will cause the display of the expanded menu 93AM, the second one will cause the selection or activation of the function of “Enlarge Screen”. This will bring up the next level menu 93AN, which asks the user how she would like to enlarge the screen, i.e., whether it will be “2 by 2”, or “3 by 3” . . . (See FIG. 11). If the ensuing user action is depressing the “2” key of the HRDC twice, for example, the screen 900 will be divided into four (or 2×2) blocks (with the display of the block indicators 901, as is shown in FIG. 12). If the user then depresses the “4” key of the HRCD 710 next, the 4^{th} block of the screen 900 will be enlarged, as is shown in FIG. 12. Thus, the HRCD key combination for such an enlargement of the lower-right portion of the screen view 900 is, the “win-man key” 72W, twice, then “2”, “2”, and “4”.

After the lower-right portion of the screen view 900 is enlarged, the user may use the scrolling tool 74U (see below) of the HRCD 710 to switch to and view other enlarged blocks of the screen 900. Double clicking the win-man key 72W on the HRCD 710 again will bring the enlarged screen back to its normal view. If the user only do the HRCD combination of double clicking the key 72W followed by the “2” and “2” keys (i.e., without the last step of pressing the “4” key), the 1^{st} block (i.e., the upper-left one of FIG. 11) will be enlarged first; thereafter, the user may use the scrolling tool 74U on the HRCD 710 to switch to and view other enlarged blocks.

Alternative View-Enlargement Means

In FIG. 2, a display enlargement wheel 74X is provided on the side of the HRCD 710 for providing another convenient means for view enlargement; (i) First, when a menu or submenu is displayed with a list of items therein in response to the user operation of the functional and number keys on the HRCD 710, such a menu or submenu will be enlarged when the user operates the display-enlargement wheel 74X, with the background view remaining unchanged; (ii) If there is no drop-down or expanded menu or the like displayed with a list of items therein, operating the display-enlargement wheel 74X will, by default, enlarge the upper-left portion of the screen; then the user may use the scrolling bars 74A/74B of the HRCD 710 (See below) to view different portions of the enlarged screen; (iii) Clicking on the wheel 74X will cause the display on the screen back to its normal-display mode.

For example, as shown in FIGS. 13-14, when a plurality of application tools on a toolbar 40T of an application 400 is displayed (FIG. 13), operating the display-enlargement wheel 74X will enlarge the display of these application tools and the toolbar 40T (FIG. 14). Evidently, the reverse operation of the display enlargement wheel 74X will cause the display of the application tools and the toolbar 40T to be reduced.

Bookmark—Interacting with TV Advertisings

The bookmark key 73X on the HRCD 710 will be used to bookmark a web page currently being displayed or a web page associated with a current TV broadcast event being shown to the user. For example, when an interesting web page is displayed to the user on a display device 900, or when an interesting TV event has just caught the user's attention, the user will press the bookmark key 73X of the HRD 710. As a result thereof, the URL or IP address of the corresponding web page will be stored or saved into the Web browser's bookmark menu 93FM such that the user may later recall or revisit such bookmarked web page. In case of viewing a TV event on a TV channel which is identified by a TV channel ID, after the user press the bookmark key 73X of the HRCD 710, it will cause the client computer 30 to send a TV-page request to the web site 300. Such a TV-page request shall include the data directly related to the TV channel ID and the current time. In response to receiving such a TV-page request, the web site 300 will send the corresponding TV web page back to the client computer 30. The client computer 30 will (a) save the URL or IP address of such TV web page into the bookmark menu, (b) cause the current TV event/channel or TV display to be displayed within a window (if it is in a “full-screen” display mode), and will also (preferably) (c) cause such a TV web page received to be displayed within a separate window next to the window of the current TV event.

It is also preferred that, after the bookmark key 73X is depressed, an expanded bookmark menu 93FM is displayed briefly, as is shown in FIG. 6, for displaying to the user, for example, that the web page “www.yahoo.com” is currently being added to the bookmark menu 93FM, and is assigned to the number “2”; If the user later want to access such bookmarked web page “www.yahoo.com”, she can just depress the bookmark key 73X immediately followed by pressing the “2” key on the HRCD 710. (Again, depressing the bookmark key 73X without pressing another key immediately thereafter will trigger the action of bookmarking a web page). In FIG. 6, the 2^{nd} item is the function of holding the display of the bookmark menu 93FM, which function is assigned to the bookmark key 73X (instead of any of the number keys 720) on the HRCD 710. This means that such a function of holding the display of menu 93FM will be activated by double clicking the bookmark key 73X. If, for example, the user does not quite remember which number the web page “www.yahoo.com” is assigned to, she can just double click the bookmark key 73X so as to hold the display of the menu 93FM.

Easy Access to Files and Applications

The access to or activation of files and application programs are similar to the foregoing access to bookmarked web pages. Depressing the “File Man” key 75D on the HRCD will bring up the display of a file manager menu 93CM (FIG. 7), which includes a list of shortcuts to files and folders and a list of numbers respectively displayed next to and associated with these file/folder shortcuts. If the pressing of the file manager key 75D is followed by pressing a number key 720 on the HRCD, it will activate the corresponding file/folder shortcut assigned to such number. In the example of FIG. 7, the “FILE-1.TXT” is assigned to “2”; Thus, to open this file “FILE-1.TXT”, the user only needs to press the “2” key after pressing the “File Man” key 75D on the HRCD 710.

The access to application programs is the same. In the example of FIG. 8, the application “GAME-1.EXE” is assigned to “2”; To activate such an application, the user only needs to press the “2” key after pressing the “Appl Man” key 75F on the HRCD 710.

Activating Recently Used Items

As shown in FIG. 6, the “0” key is assigned to the most recently bookmarked web pages; depressing the bookmark key, 73X, followed by the “0” key on the HRCD 710, (i) will first show the web page URL of the most recently bookmarked web page within the box 93R; then (ii) the corresponding web page will be displayed within a web browser. If the user is only interested in one of the web pages bookmarked previously, i.e., prior to the most recently bookmarked one, she may continuously and repeatedly depress the “0” key immediately after the bookmark key 73X (she only needs to depress the bookmark key once), until she sees the desired URL within the box 93R, at which time the user will stop pressing the “0” key so that the corresponding web page will be displayed. If, after continuously pressing the “0” key, the user pauses for a few second and then presses the “0” key again, the function of the “0” key of the HRCD 710 would have been switched back to TV-channel control, and consequently, the TV channel number “0” will be displayed in response thereto.

Similarly, (i) by using the combination of depressing the file manager key 75D and the “0” key of the HRCD 710 will bring up the recently opened files (FIG. 7); (ii) by using the combination of depressing the application manager key 75F and the “0” key on the HRCD 710 will activate the most recently used application programs (FIG. 8).

Easy Access to Application Tools

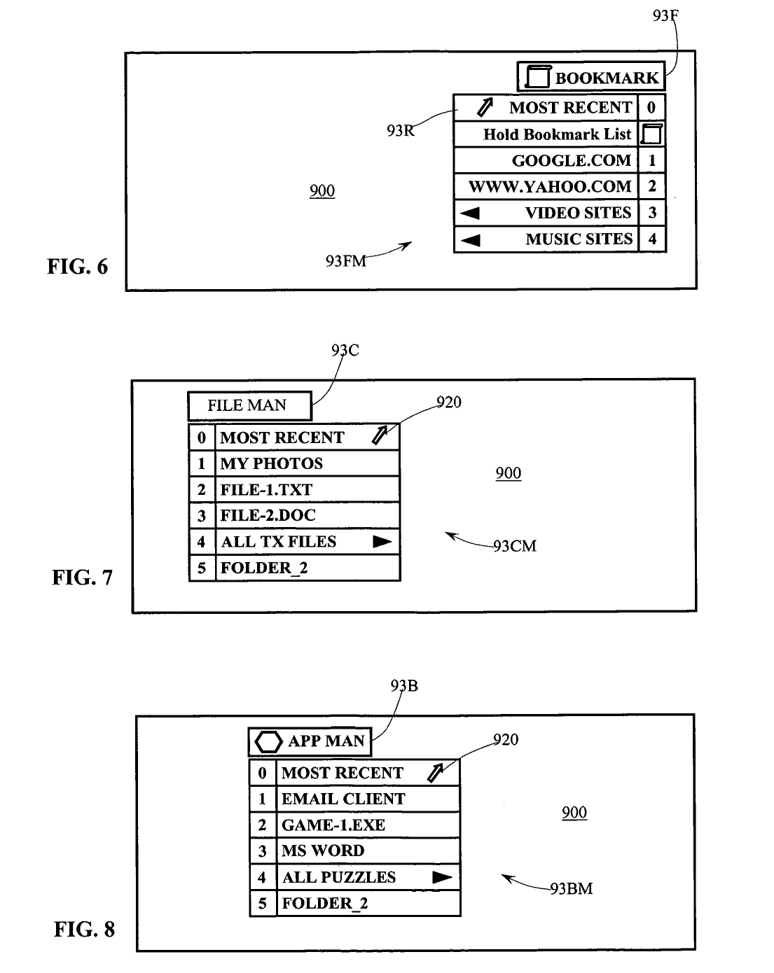

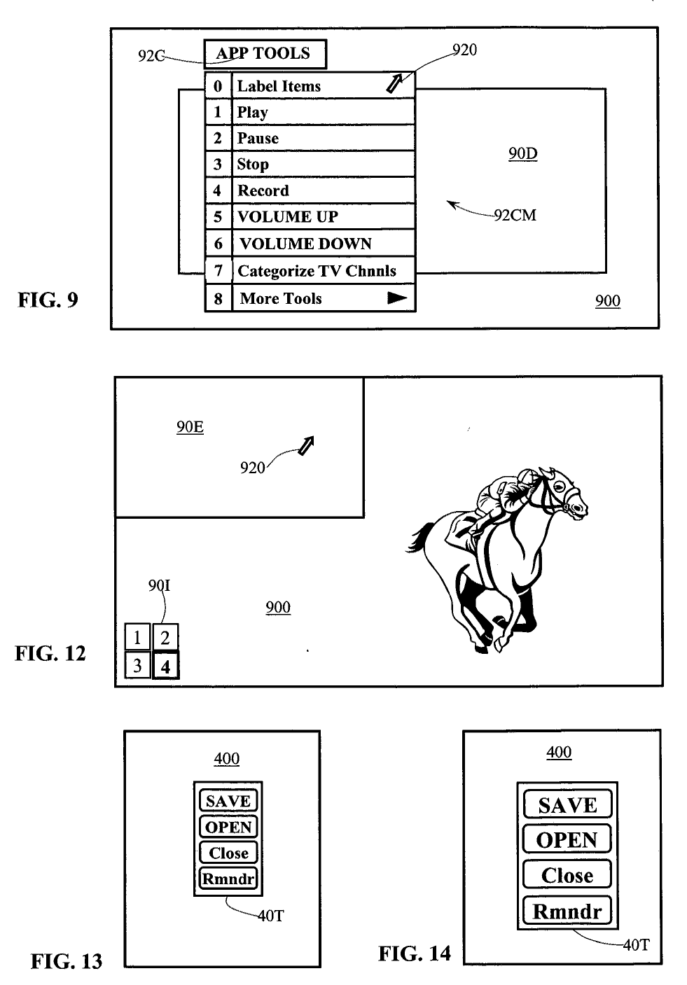

The “application tool” key 73I on the HRCD 710 is provided for access to the tool bars of the currently active application. For example, if the user is watching a video, pressing the “appl tool” key 73I will cause the display of the expanded application tool menu 92CM of a media player 90D (FIG. 9). In this example, the “2” key is assigned to the function of pausing the video; If the user presses the “2” key after the “appl tool” key 73I on the HRCD 710, it will pause the current video.

As it is shown in FIG. 2, the HRCD 710 does not have a conventional audio volume-control key. This is because, volume control is not one of the most frequently used functions. Therefore, the volume control is only included within the application tool menu 92CM; In the current example of FIG. 9, the “5” key is assigned to “volume up”, and the “6” key is assigned to “volume down”. If the user wants to turn up or change the audio volume, she will first depress the “appl tool” key 73I (only once) on the HRCD 710, followed by depressing the “5” key and/or the “6” key repeatedly and continuously until the desired volume is reached. If the user stops continuously pressing the “5” and/or the “6” keys for a short period of time (e.g., 2 seconds), and then presses the “5” key again, the TV channel 5 will be displayed, since at this moment, the function of the key “5” of the HRCD 710 would have already been switched back to the default TV-channel selection function.

Clicking on Web Links/Items without Moving Cursor

In the example of FIG. 9, the “0” key is assigned to the function of “label items”, i.e., providing a number label to each window-content item within an application window (not including any of the application tools or window control tools displayed). In this way, the user will be able to “click on” any of the items within a window by pressing the “appl tool” key 73I and the number keys 720 of the HRCD 710 (i.e., without using the track ball 74VL for moving the cursor 920 to the desired items or web links). In the example of FIGS. 17-18, if the currently active application window is 90B, which is a file folder having 4 items that are vertically aligned, pressing the “appl tool” key 73I and then the “0’ key on the HRCD 710 will cause four number labels 90LB to be listed next to these four items respectively; thereafter, the user may simply press, for example, the “2” key to activate the item “FIRSTFILE.TXT”, which is assigned to “2”. If the currently active application window is 90A, which has three items 933 randomly located therein, pressing the “appl tool” key 73I and then the “0’ key of the HRCD 710 will, similarly, cause three number labels to be displayed next to these three items respectively. After this, the user may press the corresponding number keys on the HRCD 710 to activate any of these items by looking at the screen to see which item or web link is assigned to which number label displayed.

Easy Horizontal and Vertical Scrolling; Easy Navigations of Menu Items

The scrolling mechanism 74 U on the HRCD 710 of the computer TV system is provided for scrolling display content within a window or for browsing through items within a menu displayed, and consists essentially of two identical vertical bars 74A and 74B that are separated by a small scrolling wheel 74W at the center. Thus, the three pieces 74A, 74W, and 74B form a 1-D vertical bar assembly 74U that is aligned perpendicular to the back-forth direction 74N-74S along the top surface of the HRCD 710, as is shown in FIGS. 2-4. In the drawings, the direction 74D is perpendicular to the top surface of the keypad 710. Depressing the left end 74A and the right end 74B of the assembly 74U along the vertical direction 74D will cause the scrolling of the display content within a current window horizontally in the left and right direction respectively; Pushing or pulling the bar 74B along the back-forth directions 74S-74N will cause fast scrolling of the display content (such as page by page scrolling) within the active window in the vertical directions; Pushing or pulling and then holding the bar 74B will cause even faster scrolling. The small scrolling wheel 74W is provided for the function of slow scrolling, such as line-by-line scrolling; it may also be used for browsing through items within a menu list (see next).

Whenever any of the foregoing expanded or dropped-down menus (including any of the sub- or next-level-menus) is displayed with a list of items therein in response to the user operation of the foregoing functional keys 73X, 75F, 73I, 72W, or 75D on the HRCD 710, the user may then use the small scrolling wheel 74W to browse through the items so listed regardless of the previous position of the cursor 920. During such browsing, each item being browsed through or located will be enlarged, and it may be clicked on or be activated by pressing the “Go” key 74G on the HRCD 710 after being located. The scrolling bars 74A and 74B may also be used to view different portions of an enlarged screen.

In summary, the foregoing HRCD functional keys 73X, 75F, 73I, 72W, and 75D can be regarded as task or functional categorization keys; i.e., most of the user interaction functions/tasks are categorized into these five categories. Evidently, there can be more or less than five categories, and each category may have subcategories. The foregoing HRCD number keys 720 can be regarded as task/item identification-access keys for access to each items within each category that is uniquely identified thereby. The default function of these task/item identification-access keys 720 are for selecting TV channels. It is understood that, an item within a dropdown menu may be a simple individual item or task, or it may be used for access to a subcategory or the next-level menu; and that the file manager menu 93CM, the bookmark menu 93 FM, the window-manager menu 93AM, and the application manager menu 93BM are application independent, which means the content or items within each one of these menus usually do not change when different applications are launched, whereas the item within the application tool menu 92CM is, evidently, application dependent.

Easy Typing Without Full Keyboard

In a complete computer entertainment system that is to be used in a TV-viewing environment, it would be inconvenient for a user to use a full keyboard to do the typing. The computer TV system of the present invention allows the user to use the HRCD 710 to easily do the typing. The typing keys 88k are arranged at the back side 88A′ of the HRCD 710, as is shown in FIG. 15. The TV screen of the system is shown as 900 in FIG. 16. At the back side of 88A′ of the HRCD, above the typing keys 88K, there is provided a text-display screen 88S for showing to the user what's being typed in. The reason for such an arrangement is that, (i) unlike working on a conventional computer, in a TV-viewing environment, it would be inconvenient or even exhausting for the user to keep on raising her head to see what's being typed in; (2) on the other hand, during the typing, the user usually only needs to see what's being typed in. Thus providing the text screen 88S together with the typing keypad 88k at the back side of the HRCD 710 will be sufficient for providing good typing experience for the users without making the HRCD too bulky or too expensive. In the example of FIGS. 15-16, the user is using the keypad 88K on the backside 88A′ of the HRCD 710 to type in the text 88C′/88C into a text box 88B shown on the TV screen 900. Such a method may also be applied to a cell phone, in which case FIG. 16 represents the front screen of the cell phone; FIG. 15 represents the back side of the cell phone.

Multi-Window Full Screen Mode

The computer TV of the present invention provides users with better TV-viewing experience by introducing the display mode of “multi window full screen” (or “MWFS”). In FIGS. 10-11, within the window-control menu 93AM, the number “5” key is assigned to the function of MWFS; When the user depress the window manager key 72W following by the “5” key of the HRCD 710, if there are more than one window opened, the display will be switched to the MWFS mode. While in such MWFS mode, more than one windows are displayed to substantially occupy all or almost all of the display area of the display 900. Moreover, the system allows the user to adjust (i) how many windows are to be included in such MWFS display, and (ii) the display configuration of such MWFS display. As used herein, the term “display configuration” of the MWFS display means how many windows are displayed on the display 900 and how these displayed windows are arranged in desired numbers of rows and columns.

In the examples of FIGS. 21-22, after the user depress the window manager key 72W followed by the “5” key of the HRCD 710, the display button 93A, 93B, 93C, and 93F of FIG. 26 are reduced to thin horizontal bars respectively, and the task pan 12A is also reduced to a thin vertical bar 93AN (the “reduced task pan 93AN”) having only window IDs displayed therein, so as to leave more space for MWFS display. When the computer TV (30) is in such MWFS mode, a configuration-control box 93WC is provided for control of the display configuration. The control of the display configuration is done by changing the size of the configuration-control box 93WC (by dragging one of its corners) as compared with the size of one of its child box or subordinate box 93WB which has a fixed size. For examples, (i) if the length of the configuration-control box 93WC is changed such that the size of the configuration-control box 93WC is equal to the size of 3×1 of the child box or subordinate box 93WB, then the display 900 will include three windows aligned in one row, as is shown in the example of FIG. 21; (ii) if the size of the configuration-control box 93WC is changed such that the size of the configuration-control box 93WC is equal to the size of 2×2 of the child box or subordinate box 93WB, then the display 900 will include four windows aligned in two rows by two columns, as is shown in the example of FIG. 22.

It is preferred that, the configuration-control box 93WC shall be attached to and be operated in conjunction with the foregoing reduced task pan 93AN, as are shown in FIGS. 21-22. When the configuration-control box 93WC is attached to and is used together with the reduced task pan 93AN, its child box or subordinate box 93WB will be the elements of the window ID boxes of the reduced task pan 93AN that are located within the configuration-control box 93WC, as are shown in FIGS. 21-22. In the example of FIG. 21, the size of the configuration-control box 93WC is changed to include three window ID boxes, arranged as 1×3, that have window IDs “2”, “3”, and “4” respectively; Thus, the MWFS display of the computer system includes 1×3 windows (i.e., three windows aligned in one row by three columns), including the windows 562, 563, and 564. In the example of FIG. 22, the size of the configuration-control box 93WC is changed to include four window ID boxes 93WB, arranged as 2×2 (i.e., once the width of the box 93WC is increased, additional window ID will move up into the box 93WC such that the reduced task pan 93AN will become two columns within the box 93WC, while outside the box 93WC, it still remains in one column); The 2×2 window IDs within the box 93WC of FIG. 22 are, as shown, “1”, “2”, “3”, and “4” respectively; Thus, the MWFS display of the computer system includes 2×2 windows (i.e., four windows aligned in two rows by two columns), including the windows 561, 562, 563, and 564.

When in such MWFS mode, the user can scroll different windows onto the display 900 by dragging or moving the configuration-control box 93WC down alone the reduced task pan 93AN such that different window ID will be sled into the configuration-control box 93WC, which will cause the display, on the screen 900, of the corresponding windows associated with such window IDs shown within the box 93WC. It is also preferred that, such MWFS display shall provide a window resizing function for allowing a user to change the size of any of the window displayed. In one example, window resizing buttons 568s and 569s located between the neighboring windows are provided, as are shown in FIGS. 21-22. When any of these resizing buttons 568s and 569s are dragged or moved, one of the window will be enlarged, and one or more of its neighboring windows will be reduced in size. For example, if the resizing button 569 of FIG. 22 is dragged or moved towards the lower-right direction, the size of the window 561 will be enlarged, and the size of the window 562, 563, and 564 will be reduced.

Improving TV-Channel Surfing Experience

TV-channel surfing will be one of the most frequent user activities when the computer TV 30 is used. The conventional TV system only allows the user to conduct TV channel surfing based on the TV channel numbers. In the computer TV 30, such a conventional TV channel surfing function is provided by the keys 7SA on the HRCD 710. Moreover, the computer TV 30 also allows a user to conduct TV channel surfing based on TV channel categories.

The computer TV 30 is provided with two TV channel arrangement modes, including (i) the conventional mode in which the TV channels are arranged according to the TV channel numbers only; and (ii) a “categorized mode”, in which each TV channel is assigned to belonging to a specific category. Accordingly, the TV channels surfing keys 7SA will provide the function of changing TV channel category when a user double click one of the keys 7SA. For example, all the TV channels may be divided into four categories, including: News, Sports, Movies, and Music. If the user double click the keys 7SA, it will (i) cause the TV channels to be arranged into these four categories, and (ii) cause the TV system to switch between these four categories. If, after double clicking the keys 7SA, the user does the conventional TV channel surfing by “single-clicking” one of the TV channel surfing keys 7SA on the HRC 710, the TV channel will be switched within a selected category. For example, at a particular moment, the user may only wish to surf all of the News channels available and is not interested in any other categories; If at a later time, the user wants to surf TV channels of another category, such as sports channels, the user may simply double click one of the keys 7SA to change TV channel category; After the current channel category is switched to Sports, when the user does the conventional TV channel surfing by “single-clicking” one of the TV channel surfing keys 7SA on the HRC 710, the TV channel will be switched among all the available sports channels. When the user stops double clicking the keys 7SA for ten minute (for example), the arrangement of TV channels will be changed back to the conventional way of being based on TV channel numbers. Alternatively, in FIG. 9, the application tool associated with the number “7” may be used to switch the arrangement of TV channels back to the conventional way of being based on TV channel numbers.

Desktop Live

As described above, the computer system of the present invention provides live update of personal data on the client user's desktop or as a screen savor. Evidently there may be a privacy issue when constantly transmitting personal information through the Internet; and most of the users do not feel comfortable to remain logged onto their web portal account all the times. However, there are several ways to “get around” this. (A) First, the user's web portal account may have a secondary username. Such a secondary username will be solely used for the purpose of associating or linking the user's web portal account with the user's local client desktop account. For example, if a use's web portal account username and password are, respectively, “usr-name” and “xxx-xxx”; the secondary username may be “scnd-nm”. Such a secondary user name will not be used together with a password at all. The user will not be able to use the secondary username scnd-nm to log onto her web portal account; and the secondary username scnd-nm will not be exposed when the user is doing any online activities associated with her web portal account (such as sending email or playing a chess game). The secondary username scnd-nm shall only be used together with a message ID, or live-information ID, when the client computer request live update of certain personal information associated with the user's web portal account. (B) Secondly, a user may regard many live messages or data associated with her web portal account as non-secret; Thus, these data may be transmitted from the web portal site to the user's client computer without requesting full login by the user. Let's call this type of information as Personally Preferred But Non-secret Info (or “PPBNS info”). For examples, some users may regard the number of new emails recently received, an alert signal for reminding the user of the approaching of a bill-pay deadline, or the delivery status of an auction item as PPBNS info. Such PPBNS info will be transmitted to the client computer only when the secondary username “scnd-nm” (not the primary user name “usr-name”) is used in the client computer's request. The privacy issue will be improved by separating the PPBNS info from the user's primary username “usr-name”.

(C) The third approach is to provide a dynamic message ID, or live-information ID, to each live message to be transmitted from the web portal to the user's local desktop (i.e., the message ID may change from time to time). (D) The forth approach is to divide a piece of meaningful message into sub-pieces such that each one of the sub-pieces will not reveal any meanings or secrets independently unless all the sub-pieces are put together. For example, a live message may be that the user's current bank account balance is $500. The full message may comprises 5 sub-pieces, including the username, the account number, the number “$500”, the meaning of the number $500 (i.e., current account balance), and the date. When the web portal sends a response to the client's live desktop-update request using the secondary username “send-nm”, only the number $500 needs to be transmitted from the web portal server to the client. Thus, the data “$500” to be transmitted through the Internet will not reveal any significant meaning to a third party. During the live desktop setup process, the corresponding client application will ask the user to make comments on each piece or each segment of the data to be received from the web portal during the live-desktop-update process, by referring to a My-Desktop or My Live Desktop web page of the user's web portal account (see below). For example, the user's comment on a specific live data field that is to be entered through the client application by the user may be “my bank account balance”, or “latest bid on my auction item-x”, etc. When each piece or segment of the live information data is received from the web portal during the live desktop-update process, it will be displayed on the desktop together with such comments entered by the user.

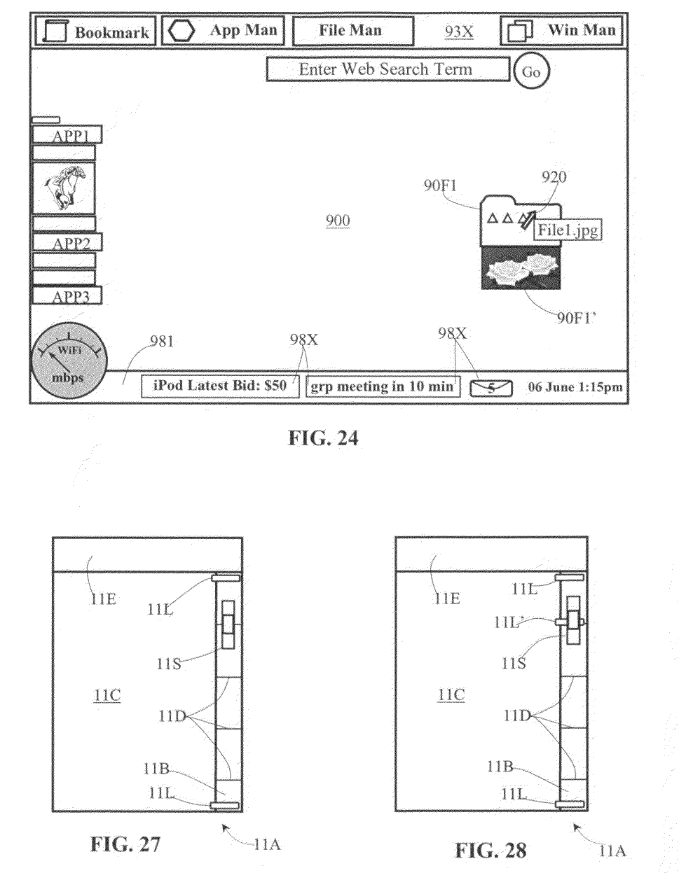

In FIGS. 24-26, a live component 981 of the desktop 900 is located at the bottom of the desktop display. In these examples, the live messages at the bottom of the desktop 900 include both live personal information received from a web portal as well as live messages associated with the user's local client calendar application (such as the message “grp meeting in 10 min” shown). As shown in FIGS. 24-26, within the live component 981, there is provided a plurality of live messages 98X received from the server 300 that are personal to the user, such as the latest bid on the user's auction item associated with an online auction account of the user. Each one of these live messages 98X on the local desktop (i) may be related to the user's online or offline activities associated with the user's subscription to the online service, (ii) will be updated regularly based on a predetermined update schedule; and (iii) are in form of small unit or small web page or the like (the “live-information unit or page”). Such small unit/page may be displayed within the live component 981, and they may be displayed sequentially (i.e., one unit/page being replaced by another based on a display rotation schedule) if there is not enough room for displaying all of the units/pages. The number of units/pages displayed within the live component 981 will be dependent on the space available. The live component 981 is a portion or a component of the desktop 900. The live component 981 will be displayed whenever the desktop 900, which is the default display of the computer system 30, is fully displayed (i.e., the computer display is in a “full-default-display” mode).

My Live Desktop Page

When providing live desktop services, (i) a fully functional web portal (such as Yahoo.com) needs to be established such that, in association with each one of the user account on each local client system, an online web portal account shall be created; (ii) in order to make it easy for the user/subscriber to select live information for update on the user's client desktop, a My-Live-Desktop web page may be provided for each user's web portal account or subscription. Such My Live Desktop page will provide a collection of live-information messages that can be presented on the user's client desktop, so as to make it easy to organize and arrange live desktop information. The user can easily choose from the My Live Desktop page which live-information messages are to be presented live on the client desktop.

Screen Savor

According to the present invention, the screen savor, or “idle display”, of the computer system is regarded as a precious display “real estate” that is to be used for displaying interactive messages such as personal information associated with an online account of the user or interactive advertising messages. The interactivity of the screen-savor is provided through a specially designated screen-savor interaction key (or “SSI key”, or “idle-display-interaction key”, such as the “Ctrl” key) on a conventional keyboard. Similar to the conventional screen savor, when a user touches the mouse or any other keys (other than the SSI key) on the keyboard, the screen savor will be turned off; i.e., the Screen Savor is untouchable; But when the user presses the SSI key first before touching any other keys on the keyboard or before touching the mouse, the screen-savor display will become fully “touchable” (i.e., it will not be turned off when the user touches the mouse or any of the keyboard keys again unless the user clicks on a “close” link provided thereon), in which case a substantial portion of or the entire screen savor or idle display will remain displayed either within a window or as full screen. When the screen savor display become fully “touchable”, the user can click on or have access to any of the links or item displayed thereon or otherwise interact with it in the same manner as interacting with any other web pages. Thus, according to the present invention, the screen savor can be used for providing and displaying interactive messages such interactive advertising messages. Such an interactive screen-savor advertising methods can be applied on cell phones as well as on any computer systems. Thus, the computer system of the present invention provides an additional media channel, the screen savor, for presenting interactive multimedia messages such as advertising messages or personal information associated with an online account of the user. As used herein and in the annexed claim, in the phrase “idle display”, the word “idle” is with respect to a user's interaction with the computer and is not pertinent to the processing or workload status of the CPU and the like. It is also understood that this aspect of the present invention with respect to the user-interaction mode of the Idle Display is not limited to be applied on personal computers, and it can be applied in any devices utilizing screen savor as idle display, such as cell phone, handheld music or game players and the like, and handheld personal assistance devices or handheld computer and the like, etc.

Collaboration

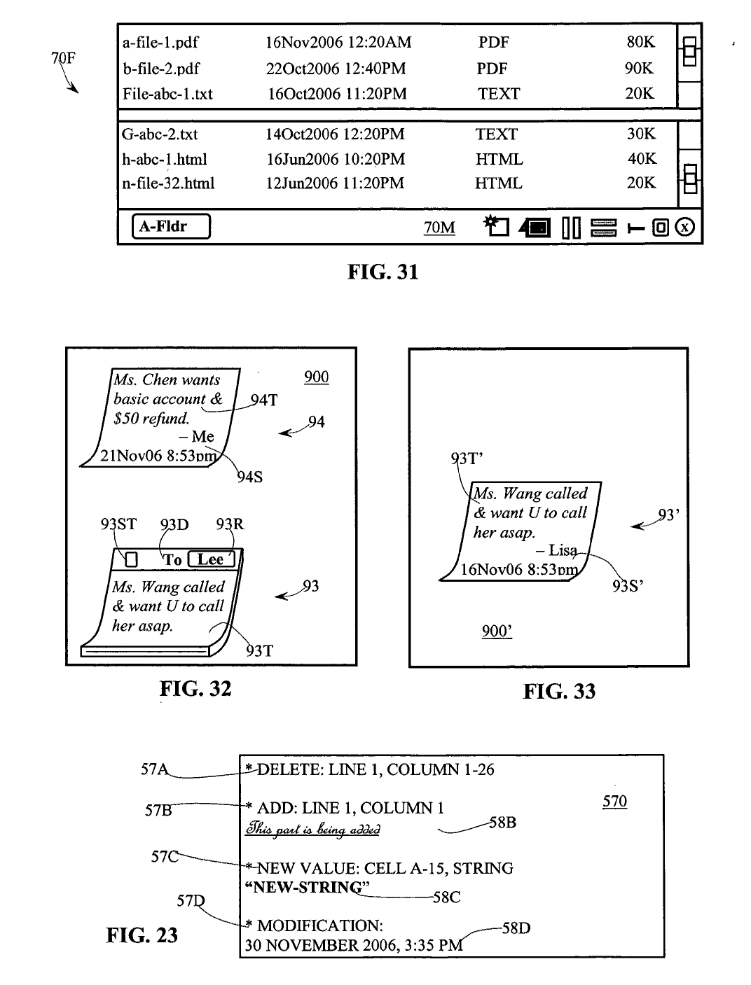

According to the present invention, a client-server computer system shall be made to facilitate real-time collaboration, i.e., more than one person can work on the same file at the same time; and each one can have live update of any other people's works. During such a collaboration process, the original file being worked on, or the “source file”, is usually stored on a file server computer 300; A copy of the source file, or the “local copy”, is copied or downloaded to the local client computer 30 of each user working on the source file. On each local computer 30, the user's recent work will be saved into the local copy in the conventional manner. In addition, the user's recent work will also be saved into a LFMU file. FIG. 23 shows a simplified exemplary LFMU file 570, which includes (i) commands or instructions 57A, 57B, 57C, and 57D, and (ii) objects or data 58B, 58C, and 58D that correspond to the commands 57B, 57C, and 57D respectively and that will be used by these commands to perform file modification. It is preferred that the LFMU file 570 is in the same file format as the source file so that the data/objects 58B, 58C, and 58D can have the same data type, format, or the like as the original data; Whereas the data type or format of the commands 57A, 57B, 57C, and 57D may preferably be in a simple or plain text format or the very basic text format of the corresponding application program. The LFMU file is different from the local copy in that, the LFMU file only needs to record the user's recent work, i.e., the differences between the current version of the local copy and the immediate previous version recorded when the user's work was most recently sent to the file server for update. The LFMU file only needs to include the local user's own recent work; it's not necessary to include any work done by other collaborators received during an update process. Every LFMU file shall include a timestamp 58D and user ID information so as to give the file server 300 an instruction on the sequence of update. While working on the local copy, when the local user decides that its time to give her co-workers update on her recent work, she will just click on a “update-put” button. Consequently, it will cause the LFMU file to be sent to the file server 300. When the file server receives the LFMU file, the OS will be triggered to perform the LFMU process, which includes: (i) executing the application program associated with the source file so as to open the source file; and (ii) modify the source file according to the instructions and data included in the LFMU file received.

In general, the LFMU file may contain one or more of any type of file elements, for indicating changes or modification of the corresponding file, and the position or location information associated therewith. Examples of such file element types may include (but not limited to) the followings: (1) text (with or without format information), (2) an object or the like (of any file type), (3) a layer or the like (such as in case of drawing or other file type), (4) a sheet or the like (such as in case of spreadsheet or other file type), (5) a column or row or the like (such as in case of spreadsheet or other file type, or within a table), (6) a block of contents, (7) a surface or the like (such as in case of 3-D drawings), (8) a table or the like, (9) one or more elements or cells within a table or spreadsheet, (10) an image, and/or (11) a web link (such as in case of a web page or the like), etc.

It is understood that, any of these file elements may (or may not) include programs that cause its visual position to move from one point to another. The LFMU file may also include information that is not directly related to the main body of the file, such as (a) bookmark information or the like, (b) comments by an author or the like, (c) visible or hidden links or the like, or (d) security-related information or the like, (e) file update information or the like etc.

As for update of the local copy on each client computer, each client computer will constantly send status request to the file server for requesting the status of the source file. Such a status request will include information about the timestamp (or other ID information) of the most recent LFMU file received from the file server. In response to such a status request, if it is determined that there is new LFMU file received or new LFMU process performed on the source file that is associated with other user's works (evidently it shall not count the requester's own update) as compared with the timestamp information included in the request, the file server will send a brief “new update” signal to the requester's client computer 30, which will cause the local computer 30 to remind the local user that there is new update by one of her collaborators. If the local user decides that she want to see the new update, she will click on a “update-get” button provided. Consequently, the LFMU file deemed “new” will be sent from the file server 300 to the client computer 30. Once the local computer 30 receives the new LFMU file from the file server, the OS of the local computer 30 will be triggered to perform a local LFMU process. The local LFMU process includes two parts: (i) modifying/updating the local copy based on the LFMU file received; and (ii) updating the display accordingly.

It is understood that, the LFMU file 570 may include many other commands, instruction, or information. For example, if a source file is stored on a file server (or a central computer), a first user working on this source file on a first remote computer may want to have a portion of the source file to be locked (i.e., “partial lock”) so that other people working on the same source file online at the same time are not allowed to modify such locked portion. In this way, the first user will be the only user allowed to modify such locked portion of the source file. The first user may lock a (or a few) paragraph(s)/section(s) of a word processor file or of a slide-show presentation file or the like, a column, a row, a table, or a sheet of a spreadsheet, or an object or a layer of a graphic file, etc. The information relating to such partial locking of the source file, together with other live file modification update related information (such as text editing related update information, newly added or modified data, objects, layers, sheets, etc., and information of deleting or changing of text, data, objects, layers, sheets, etc.), can be included into the LFMU file 570. Then, after the user click on said update-put button, the file 570 will be transferred to the file server (or the central computer serving the source file) for update. When there is a second user working on the same source file on a second remote computer at the same time, both the first and the second remote computers will constantly send a file-status inquiry to the file server for inquiring about the update status of the source file. After a new LFMU file 570 is received by the file server from the first remote computer, (i) the file server will performance the update of the source file accordingly, and (ii) the file server's response to the second computer's file-status inquiry will indicate that there is a new update to the source file; Then the second computer will remind the second user that there is new update to the source file. The second user can then choose to receive the new update by clicking on the “Update-get” button. If there is no new update to the source file, server's response to the second computer's file-status inquiry will indicate so.

Once the information relating to the foregoing partial lock of the source file (together with other file update information and commands or instructions) in the LFMU file 570 is received by the second remote computer, the second remote computer will perform the update accordingly, and consequently, the second user will no longer be allowed to modify the portions of the source file so locked by the first user. For example, if a paragraph (or a few paragraphs) is locked by the first user, the first user may still modify the portion(s) so locked in the regular manner (such as adding or deleting texts, dividing a paragraph into many paragraphs, and formatting or editing texts, etc.), whereas the second user will not be allowed to do these tasks. The file locking by the first user can be done by, for examples, adding virtual (i.e., invisible to the users) lock marks (or flags) to the locked portions of the source file. This is usually done through one or more lock-start/lock-end pair(s), i.e., putting the lock-start flag(s) at one end of the object or segment that is to be locked by the first user and the lock-end flag(s) at the other end of the object or segment. For examples, (i) if the source file is a word document file, and the desired locked portion is a (or a few) paragraph(s), one virtual lock mark or flag may be added to the beginning and one to the end of such desired locked paragraph(s); (ii) if the source file is a spreadsheet, and the desired locked portion is a group of cells or objects, then each one of these cells or objects may be given a virtual lock mark, etc. The virtual lock mark may include the user-ID information or the like of the first user (i.e., the user who made the locking). It is also preferred that, when a remote user on a remote computer finishes working on the source file on the file server, before closing the file, the remote user will be reminded to update the source file on the file server if it has not been done.

Context Menu

One of the advantages of the GUI of the MS Windows OS in the market is that, each item display is provided with a “Context Menu” that provides a list of many options or functions associated with such display item; The access to the Context Menu is by “right-click” the mouse. Similarly, in the computer system of the present invention, each display item is also provided with a context menu; and the access to which is also by “right-clicking” (or alternatively “left-clicking”). But, instead of right clicking a mouse, the context menus associated with each display item is accessed by either (i) using the cursor 920 to click on the right end area or the upper-right corner area of the display item, or (ii) double clicking a “Go” key on a remote control device after such item is located. If the item is displayed as a linear horizontal item, e.g., the item 94B of FIG. 26, then the right-end area 94PK of such an item shall be used for access to the corresponding context menu, i.e., clicking on the right end 94PK of the item 94B will bring on the context menu of such an item. Also in FIG. 26, the item 94G's upper-right area 94PK is being clicked on by a cursor, which brings up the context menu 94MN of the item 94G. On this exemplary desktop 900 of FIG. 26, an Email icon 95C and the number 95C′ therein indicate that there is currently one new email.

Transparent Folder Cover

The computer system of the present invention provides novel methods for folder display and file management. As shown in FIGS. 24-26, the cover of an unopened file folder (90F1, 90F2, 90F3) may be made transparent such that a user may see, through the folder cover, how many items or files are included in each folder and what types of file are in each folder. This is realized by using “file indicators” in each folder. A file indicator has a predefined color and geometric shape for representing a type of file or item, and these predefined geometric shapes/colors (i.e., the “file indicator”) may be seen by the user “through” the cover of an unopened folder. For example, a “jpg” file's file indicator may be predefined as a small white triangle; Thus, when a user see many small white triangles through the cover of a folder, the user will know that there are many “jpg” files within such a fold even when the folder has not yet been opened.

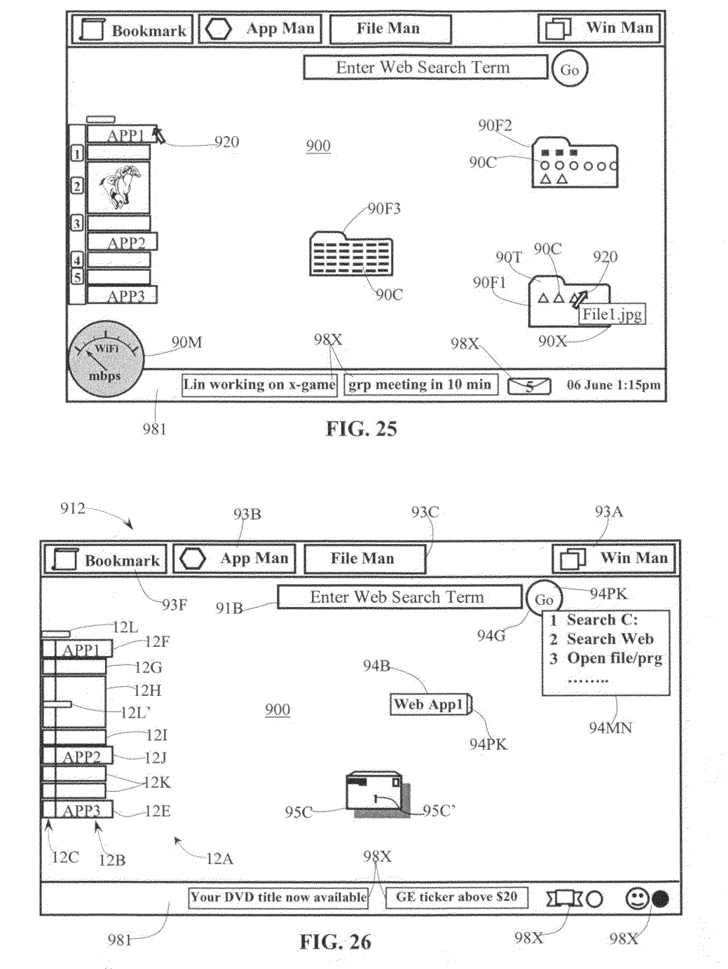

In the example of FIG. 25, there are three folders 90F1, 90F2, and 90F3 on the desktop display 900: (i) the exemplary folder 90F1 includes 3 file indicators 90C of the same type; thus a user will immediately know that there are three files/items of the same type within the folder 90F1; (ii) the exemplary folder 90F2 includes 11 file indicators 90C of three different kinds, including three black squares for representing three “txt” files, six circles for representing six “exe” files, and two white triangles for indicating two “jpg” files; Thus a user will immediately know that there are three “txt” files, six “exe” files, and two “jpg” files included within the folder 90F2 before even opening the folder 90F2; (iii) the exemplary folder 90F3 includes many file indicators 90C of unidentified shapes; thus the user will immediately know that there are many items/files of different kinds in the folder 90F3. The arrangements of the display of these file indicators are as follows: (i) the files of the same type are aligned along one row; (ii) the most recently used files are arranged sequentially from left to right; and (iii) different file types are situated on different rows with the most recently used one located on the top row. In this way, the user may easily find the most recently used files.

In the case of the exemplary folder 90F1, when the cursor 920 is moved to one of the file indicator and remain there for 2 seconds, for example, the name 90X of the associated file (“File1.jpg”) will appear. Moreover, the cover of the folder 90F1 may include a small predefined cover-open area 90T such that when the cursor 920 is moved to such cover-open area 90T (i.e., on-mouse-over), the cover 90F1′ of such folder will flip open for allowing the user to click on and to activate any of the items therein. On such flip-opened folder cover 90F1′, a file image of the file “File1.jpg” located by the cursor 920 will be displayed (See FIG. 24). When the cursor 920 is moved away from the folder 90F1, the cover 90F1′ will automatically close.

Scrolling Marks

When a user is scrolling a display content within a window, often she is in need of switching the view from one scrolling position to another. With respect thereto, the present invention substantially improves such user experience by allowing the user to mark a scrolling position/view during the scrolling so as to easily return to the marked scrolling position/view with a single click.

Reference is now made to FIGS. 27-28, in which is shown a (graphic user interface) display of a general-purpose application 11A. The application 11A includes application-display information 11C, a toolbar section 11E and a scrollbar section 11B. A scroll box or scroll button 11S is situated on the scrollbar 11B. As usual, a user can drag the scroll box/button 11S along the scrollbar 11B to browse through the display information 11C of the application 11A. In addition to these conventional scrolling features, (i) a small window is provided at the center of the scroll button 11S for indicating the size of the current window display relative to the length of the display information 11C which is represented by the length of the scroll bar 11B, (ii) the scrollbar 11B includes a plurality of page indicators 11D along the scrollbar 11B, with each of the page indicators 11D comprising a small cross line, as are shown in FIGS. 27-28; and (iii) a page mark (or position marker, or scrolling mark) 11L is provided at each end of the scrollbar 11B. The page indicators 11D are provided for the purpose of indicating the page number of the current position of the scroll button 11S. When the scroll button 11S is dragged along the scrollbar 11B, two of the page indicators 11D, one above the small window at the center of the scroll button 11S and one below the small window at the center of the scroll button 11S, will each be changed from a cross line to the corresponding page number. The scroll button 11S may be made partially (or fully) transparent such that the user can see the page number of the page indicator 11D through the scroll button 11S while it passes through along the scrollbar 11B. The number of page indicators 11D on the scrollbar 11B may be dependent on the total number of pages of the printout view of the display information 11C. If such total number of pages is small, such as less than ten pages, then the number of page indicators 11D on the scrollbar 11B may be made the same as the total number of pages (i.e., one page indicator for each page); If such total number of pages is large, the number of page indicators 11D on the scrollbar 11B may be less than the total number of pages, such that the density of the page indicators 11D on the scrollbar 11B will not be too high. For examples, If the total number of pages is (i) 100, then the scrollbar 11B may include 10 page indicators 11D, i.e., one page indicator for every 10 pages, (ii) 44, then the scrollbar 11B may include 10 page indicators 11D, i.e., one page indicator for every 5 pages, etc.

The page marks (or position markers) 11L are provided for the purpose of marking the position of a particular scrolling view on the scrollbar 11B. By default, the top and bottom ends of the scrollbar 11B are each provided with a permanent page mark 11L. Clicking on the two permanent page marks 11L will cause the current window 11A to display the top and bottom portions, respectively, of the display information 11C. Moreover, a “copy” of the permanent page mark 11L may be dragged to any position on the scrollbar 11B. For example, in FIG. 28, a “copy” 11L′ of the page mark 11L has been dragged to the position associated with page 2 on the scrollbar 11B. Thereafter, if the user move to another position or view of the display information 11C and thus the current display is not at page 2, clicking on the page mark 11L′ will cause the current window 11A to switch back to such page 2. Usually the page mark 11L′ is dragged right to the position of the scroll button 11S, in which case it would look like that the page mark 11L′ is dropped “under” the scroll button 11S on the scrollbar 11B. If the user does not need the page mark 11L′ anymore, she may just drag it and return it back to one of the permanent page marks 11L. Moreover, in addition to manually putting the page mark 11L′ onto the scrollbar 11B, the page mark 11L′ may also be automatically put onto the scrollbar 11B by the scroll button 11S if the scroll button 11S stays at a position on the scrollbar 11B for more than a predetermined period of time. For example, if the scroll button 11S stays at the position associated with page 2 on the scrollbar 11B (FIG. 27) for more than, for example, 10 seconds, then a page mark 11L′ will be automatically added onto the scrollbar 11B at said page-2 position. If the scroll button 11S is then moved away from said page-2 position on the scrollbar 11B, (i) the user may come back to the page-2 view by clicking on the page mark 11L′; (ii) if the user does not click on or otherwise use the page mark 11L′ for a predetermined period of time (such as for 2 minutes), then the page mark 11L′ may automatically disappear (either immediately or slowly fading away).

Desktop Task Pan

The computer system 30 also provides users with better ways of desktop task management. Reference is made again to FIGS. 24-26, in which is shown a simplified computer desktop view 900. The desktop 900 includes a task pane 12A, on which is situated the task indictor of each launched task or window (i.e., the minimized view of a window). The task indictor on the task pane 12A may be either a task button (hereinafter, the “TB”), in which case a window is represented by a button on the task pane 12A, or a task image, in which case a window is represented by a reduced task view (hereinafter, the “RTV”) on the task pane 12A. The RTV is a reduced view of the corresponding window, and maintains the (live) graphic, display, and imaging characteristics, with a reduced size, of the original window. The window may be currently open or minimized. The buttons or icons or shortcuts associated with the user's favorite applications are also included and shown on the task pane 12A. It is preferred that the task pane 12A is located at the left (or right) side of the desktop 900 instead of at the bottom or top of the desktop 900, because most of the computer monitors sold in the market are wide-screen monitors. As shown in FIG. 26, the exemplary task pane 12A includes three buttons/icons associated with three applications, including, respectively, applications 12F, 12J, and 12E. Clicking on these application buttons will launch the respective application programs. The task pane 12A of FIG. 26 also includes a plurality of the foregoing TBs and RTV, including (i) two TBs, 12G and 121, and a RTV 12H that are listed under the application button 12F and are associated with three windows launched in connection with the application 12F, and (ii) two TBs 12K that are listed under the application button 12J and are associated with the two windows launched in association with the application program 12J. In the example of FIG. 26, there is no window launched in association with the application 12E.

On the task pane 12A, the RTV 12H is, again, a reduced view of a window associated therewith. When the user uses the mouse to browse through the task pane 12A from, for example, the RTV 12H to the TB 121, the RTV 12H will be further reduced to a TB (i.e., it becomes a button or a minimized window), and the TB 121 will be enlarged into a RTV for displaying to the user a reduced view of the corresponding window. Such a switching of display from a TB to a RTV will be performed sequentially when the user move the mouse along the task pane 12A from top to the bottom; it will appears that the switching occurs between the neighboring TB and RTV. If there is enough vertical space on the task pane 12A, every task indicator thereon will be shown as a RTV; when more windows are launched, there will be time when there is not enough room on the task pane 12A, upon which some of the RTVs, such as the ones associated with the earliest-launched windows, will be reduced to TBs.

The display of the task pane 12A includes a reduced mode 12C. When a user needs more space on the desktop 900 for his work, he will click on a button on the task pane 12A to reduce the full-sized task pane 12A to the reduced-size mode 12C. Similar to the scrolling mark 11L of FIGS. 27-28, the task pane 12A includes a permanent window mark 12L. One or more “copies” 12L′ of the window mark 12L can be dragged onto any of the RTVs or TBs on the task pane 12A. The purpose of providing the window mark 12L′ is to make it easy for the user to locate the window that is used frequently when there are many windows launched, especially when the task pane 12A is in its reduced mode 12C. Clicking on the window mark 12L′ will be equivalent to clicking on the TB or the RTV on which is situated the window mark 12L′, which will bring up the associated window to the front. When the task pane 12A is in its reduced mode 12C, the window mark 12L′ and the reduced task pane 12C will always be visible to the user (i.e., always on top). In the example of FIG. 26, the window mark 12L′ has been dragged onto the RTV 12H; clicking on the window mark 12L′ will bring up the window associated with the RTV 12H to the front.

Novel Folder Search Method

Another novel user interface feature of the present invention is, it provides more intuitive and convenient ways to let users to conduct searching within a folder. Reference is made again to FIGS. 29-30, in which is shown a file folder 70F for management of files stored on the local computer 30. As shown, the file folder 70F includes a subfolder 81 and a plurality of local files 82, 83, 84, 85, 86, and 87, with the detailed file information thereof, including the filenames, modification times, file sizes, and file types being displayed and arranged in four columns respectively in FIG. 29. The folder 70F includes a folder name tag 70× and a plurality of conventional functional buttons 70T. In addition, (i) a filename button 70N and a filename search box 70N′ are provided on top of the filename column; (ii) Similarly, a time button 70K and a time-search box 70K′ are provided on top of the modification time column; (iii) a file type button 70W and a file type search box 70W′ are provided on top of the file type column; and (iv) a file-size button 70S and a file-size search box 70S′ are provided on top of the file size column. As for the search boxes 70N′, 70K′, 70W′, and 70S′, entering appropriate search terms therein and hitting the “return” key on a keyboard will cause the folder 70F to highlight the files that meet the search criteria. For examples, as shown in FIG. 30, (i) the search term “*abc*” is entered into the file-name search box 70N′; consequently, the file names that contains the string “*abc*”, including the files 84, 85, and 86 of FIG. 29, are highlighted; (ii) the search term “Apr. 31, 2006-Oct. 15, 2006”, which is a time period, is entered into the time-search box 70K′; thus the file times that fall into this time period, including the files 85, 86, and 87, are highlighted, (iii) the search term “HTML” is entered into the file-type search box 70W′, and hence all the HTML file types, including the files 86 and 87, are highlighted; and (iv) the search term “30K-40K”, which is a file size range, is entered into the file-size search box 70S′; and file sizes that fall into this range, including the files 85 and 86, are highlighted. It is appreciated that, such a way of file search and of displaying search results are more intuitive: the user can immediately tell which file meets which searching criteria. For examples, in FIG. 30, the user can immediately tell that, only the file 86 meets all the four search criteria of the four search boxes 70N′, 70K′, 70W′, and 70S′; and the file 85 meets the two search criteria in the two search boxes 70N′ and 70K′, etc. Moreover, a search-result button 70B is provided on the toolbar such that clicking on the button 70B will cause the folder 70F to display only those files that meet any of the foregoing search criteria, and to hide those files that do not meet any of these search criteria, such as the files 82 and 83. In addition, a subfolder expansion button 70A is provided such that clicking on the button 70A will cause the files that are located within the subfolder 81 and meet the foregoing search criteria to be displayed.

i-Poster Note

Reference is now made to FIGS. 32-33. As it is well known, paper poster note is widely used in all office environment. Often, an office worker writes a brief message on a small piece of yellow paper or the like and post or tape it on his/her computer monitor frame or on the computer monitor frame of another person. According to the present invention, such a paper poster note can be replaced by an electronic one (i.e., the “i-poster note”) that is to be posted on a computer desktop. Same as the conventional paper poster note, examples of the typical type of messages to be included in an i-poster note include (but not limited to), (i) tasks that need to be performed on an ASAP basis when it is posted on the user's own computer desktop; or (ii) messages that need to call an coworker's immediate attention when it is posted on such coworker's computer desktop, and usually without requesting replay by such coworker. Thus, the i-poster note's function is clearly different from that of other communication means such as email or IM (instant messaging). The i-poster note is suitable for collaboration between two people who work closely together, such as between an executive and his/her assistant, and for anyone who constantly has daily contact with clients or partners.

The i-poster note includes a composer 93 that may be situated on the desktop 900 of the user's local computer 30. The i-poster composer 93 has a plurality of tools 93ST, 93D, and 93R, and a message composing section 93T. When the user wants to post a brief message, he/she may simply click on the message composing section 93T of the i-poster composer 93 to activate the i-poster note; then the user may start typing. Alternatively, the composer 93 may always remain activated on the desktop 900. After finishing writing the message 93T, the user can click on a send message button 93D so as to post the message 93T onto the desktop 900′ of a designated remote computer 300 (FIG. 33) or onto the desktop 900 of the user's own computer 30. The user may also simply use the mouse to drag the message 93T out of the composer 93 and drop it to or post it on a different position on the same desktop 900 (FIG. 32). After the message 93T is posted on the user's own desktop 900 or on a remote computer's desktop 900′, it will be displayed as a i-poster note 94 and 93′ respectively, and the content or message contained therein will, preferably, not be allowed to be edited. When the posted notes 94/93′ are deleted by the user, they may be stored in a designated folder.

The button 93R is, preferably, in form of a dropdown menu or the like that includes a list of shortcuts to the IP addresses or the like (or domain names) of the respective remote computers the desktop of which the i-poster message 93T may be posted on. Such IP addresses or domain names or the like of the remote computer shall be setup during a setup process when a setup button 93ST of the i-poster composer 93 provided therefore is activated. During the same setup process, the user may determine and select which other users are allowed or permitted to post i-poster note onto the user's own computer desktop. As shown it FIG. 33, the i-poster note 93′ posted on the desktop 900′ of the remote computer 300 includes a message section 93T′, which is written through and received from the composer 93, and a message source section 93S′ for indicating when and by whom the i-poster note 93′ was posted onto the desktop 900′. Similarly, the i-poster note 94 posted on the user's own desktop 900 also includes a message section 94T and a message source section 94S, which indicates that the i-poster note 94 was posted by the user himself or herself.

Splitting and Folding a Window

When a user is working on a computer, often she needs to work with two windows at the same time, such as when moving an item from one folder to another, or when comparing different parts of a web page, or when comparing two different documents, etc. In order to better facilitate such user activities, the computer 30 provides a window manipulation function of “Splitting Window”, i.e., splitting a window into two sub-windows, either horizontally or vertically. Such a function is included in the window-control tools at the bottom 70M of the window 70F of FIGS. 29-31. FIG. 29 shows an exemplary folder 70F; FIG. 31 shows the folder 70F of FIG. 29 after it is folded (see next) and split into two sub-windows.

As it is well known, many of the applications include a lot of tool bars at the top of the application window. Some of these tool bars take large display spaces, which could make it inconvenient for a user, especially when the user is working on multiple windows at the same time. The computer 30 provides the window-control function of “folding a window”, which is equivalent to hiding a portion of the window, such as the tool bar portion of the window. Evidently, such window “folding” can be performed along any line through the window, either horizontally or vertically. Such a window folding function is included in the window-control tools at the bottom 70M of the window 70F of FIGS. 29-31. Again, FIG. 31 shows the folder 70F of FIG. 29 after it is folded and split into two sub-windows.

The invention claimed is:

1. A computer system comprising:
a processor for processing a computer-processing-instruction system including a window-based operating system;
at least one memory device coupled to said processor,
a network subsystem coupled to said processor for facilitating communications with an electronic network,
a HRCD-input subsystem coupled to said processor for receiving a HRCD signal from a HRCD; said HRCD including a plurality of number keys and a plurality of task-categorization keys,
a display subsystem coupled to said processor for connecting with a display device and for facilitating a computer display to be displayed on said display device, and
a TV subsystem coupled to said processor for receiving a TV signal from a remote TV broadcast system and for facilitating a TV display represented by said TV signal to be displayed on said display device, wherein said TV display and said TV signal are on a first TV channel;
said computer-processing-instruction system further including a user-interaction component comprising the steps of:
in response to receiving a first HRCD signal from said HRCD, causing a menu to be display on said display device, wherein said first HRCD signal represents a user's activation of a first task-categorization key, and wherein said menu includes a list of a plurality of items and a list of task numbers that are displayed next to said plurality of items respectively such that each one of said plurality of items is uniquely associated with one of said task numbers;
in response to receiving a second HRCD signal from said HRCD, said second HRCD signal representing said user's first operation of said number keys on said HRCD and thus being uniquely associated with a corresponding number, determining whether said corresponding number is included in said list of task numbers,
in response to a determination that said corresponding number is included in said list of task numbers, activating an item within said menu that is uniquely associated with said corresponding number, and
in response to receiving a third HRCD signal from said HRCD, said third HRCD signal representing said user's second operation of said number keys on said HRCD and thus being uniquely associated with a corresponding second number, causing said TV display to be switched to a second TV display that is on a second TV channel uniquely identified by said corresponding second number.

2. The computer system as set forth in claim 1, wherein a current window is opened and displayed, wherein said HRCD further includes a pointing device, and wherein said menu includes a window-manipulation item that is to be used together with said pointing device for the purpose of changing the position of said current window prior to said receiving said third HRCD signal.

3. The computer system as set forth in claim 1, wherein a current window is opened and displayed, wherein said HRCD further includes a pointing device, and wherein said menu includes a window-manipulation item that is to be used together with said pointing device for the purpose of changing the size of said current window prior to said receiving said third HRCD signal.

4. The computer system as set forth in claim 1, wherein a current window is opened and displayed, and wherein said menu includes window-manipulation item for closing, minimizing, resizing, or causing full-screen display of said current window.

5. The computer system as set forth in claim 1, wherein said menu is application independent.

6. The computer system as set forth in claim 1, wherein said menu comprises shortcuts or links to files, file folders, application programs, or web pages.

7. The computer system as set forth in claim 1, wherein an application program is executed and is displayed within a window, and wherein said menu comprises application tools of said application programs.

8. A computer readable medium storing a computer processing instruction system adopted to be used in a multi-purpose computer system,
said multi-purpose computer system including,
a processor for processing said computer processing instruction system,
a network connection device coupled to said processor for facilitating communication between said computer system and an electronic network, and
a display device coupled to said processor for displaying a computer display including a default desktop display, said computer display including a full default display mode for fully displaying said default desktop display;
said computer processing instruction system including,
a live-information-display component for causing a live component to be regularly situated on and be displayed as an integrated full-default-display component of said default desktop display, and be displayed to a user whenever said computer display is instructed to be in said full default display mode;
said live component including live information represented by live information data received from a remote computer through said electronic network, said live information data having a text format data type and including textual data pertaining to textual, logical, or numerical description of a live or recently occurred event;
said user being subscribed to and thus being a subscriber of an online service;
said live information data being originated by said online service;
said online service providing each one of its subscribers with at least one service of facilitating an online activity of or performance of action by, or of collecting or recording information related to an offline activity of or performance of action by said each one of its subscribers;
said live information comprising a plurality of live-information units or pages that are to be displayed either sequentially or simultaneously within said live component;
said live information further including comments provided by said user during a live-desktop setup process;
each one of said live-information units or pages including said user's personal information associated with said at least one service and being updated regularly based on a predetermined update schedule such that display of said each one of said live-information units or pages within said live component shall service the purpose of giving said user updated information related to said user's subscription or to said at lease one service provided to said user by said online service that is personal to said user.

9. The computer readable medium as set forth in claim 8, wherein said live information data comprises a plurality of data segments corresponding to said plurality of live-information units or pages respectively, wherein each one of said data segments is associated with a unique live-information ID provided by said online service, said unique live-information ID being changed from time to time by said online service.

10. A method adopted to be used in a computer system,
said computer system including:
a processor,
at least one memory device coupled to said processor,
a network subsystem coupled to said processor for facilitating communications with an electronic network,
a display subsystem coupled to said processor for connecting with a display device and for facilitating a computer display to be displayed on said display device,
a TV subsystem coupled to said processor for receiving a TV signal from a remote TV broadcast system so as to facilitate a TV event represented by said TV signal to be displayed on said display device, said TV subsystem having a plurality of TV channels represented by a plurality of TV-channel IDs respectively, and
a HRCD-input subsystem coupled to said processor for receiving wireless HRCD signals from a HRCD;
wherein said TV signal is on a first TV channel identified by a first TV-channel ID;
said method comprising the steps of:
in response to receiving a first HRCD signal from said HRCD, sending a request to a remote computer through said electronic network for requesting a TV-event web page, or the web-page address thereof, that is associated with said TV event; said request including a first data segment directly associated with said first TV-channel ID and a second data segment directly associated with the time of said receiving said first HRCD signal;
receiving said TV-event web page from said remote computer,
causing said TV-event web page to be displayed within a second window, and
saving the web-page address of said TV-event web page.

11. The method as set forth in claim 10, wherein said TV event is displayed as full screen; said method further comprising the steps of, causing said TV event to be displayed within a first window.
